(19) United States
(12) Patent Application Publication
(10) Pub. No.: US 2003/0132382 A1
(43) Pub. Date: Jul. 17, 2003

(54) System and method for inspecting a mask

(76) Inventor: Michael R. Sogard, Menlo Park, CA (US)

Correspondence Address: The Law Office of Steven G. Roeder, 5560 Chelsea Avenue, La Jolla, CA, 92037, US

(21) Appl. No.: 10/026,379

(22) Filed: Dec. 18, 2001

(51) Int. Cl. G01N 23/04

(52) U.S. Cl. 250/311; 250/307

(57) ABSTRACT

An inspection system (100) for inspecting a mask (101) to determine if the mask (101) has at least one desired transparent area (902) organized in a desired transparent pattern (908) and at least one desired opaque area (900) organized in a desired opaque pattern (906). The mask (101) includes an actual mask pattern (103C) having at least one actual transparent area (103A) and at least one actual opaque area (103B). In one embodiment, the inspection system can include a beamlet supply assembly (111) that (i) directs a shaped beamlet towards one of the actual areas (103A, 103B) of the mask (101), and/or (ii) directs a plurality of beamlets simultaneously towards the mask (101).

### FIELD OF THE INVENTION

The present invention is directed to system and method for inspecting a mask for an exposure apparatus.

### BACKGROUND

Exposure apparatuses are commonly used to transfer patterns from a reticle onto a semiconductor wafer during semiconductor processing. A typical exposure apparatus includes an illumination source, a reticle stage assembly that retains a mask (also referred to as a “reticle”), a lens assembly and a wafer stage assembly that retains a semiconductor wafer. The patterns from the mask are transferred to the wafer by the exposure apparatus. The size of the features within the patterns on the mask are extremely small. Unfortunately, errors in features within the patterns on the mask will subsequently lead to errors in the wafer and possibly reduced yield of the devices patterned on the wafer.

In light of the above, there is a need for an inspection system and method for quickly and/or accurately inspecting a device such as a mask.

### SUMMARY

The present invention is directed to an inspection system for inspecting a mask. The mask includes an actual mask pattern having at least one actual transparent area and at least one actual opaque area. In one embodiment, the inspection system is used to determine if the actual pattern on the mask is similar to a desired pattern having at least one desired transparent area organized in a desired transparent pattern and at least one desired opaque area organized in a desired opaque pattern.

In one embodiment, the inspection system includes a beamlet supply assembly that directs a shaped beamlet towards one of the actual areas of the mask. In this embodiment, the shaped beamlet has a beamlet characteristic that corresponds to a desired characteristic of one of the desired areas. In this embodiment, the shaped beamlet can have (i) substantially the same cross-sectional size and shape as one of the desired areas, (ii) substantially the same cross-sectional size and shape as one of the desired opaque areas, and/or (iii) substantially the same cross-sectional size and shape as one of the desired transparent areas.

Depending upon the size and shape of the desired area, the shaped beamlet can be adjusted to have a cross-sectional size and shape that is at least approximately 5%, at least approximately 10%, at least approximately 20%, at least approximately 50%, at least approximately 70%, at least approximately 90%, or approximately 100% of the size and shape of one of the desired areas. For example, to inspect a square desired area that is 100 nanometers by 100 nanometers, the shaped beamlet can have a 100 nanometer square shape. In this design, the size and shape of the shaped beamlet is 100% of the size and shape of the desired area. Alternately, for example, to inspect a rectangular shaped desired area that is 10 microns by 100 nanometer, the size and shape of the shaped beamlet can be approximately 10% of the size and shape of the desired area.

The inspection system can also include a detector assembly for inspecting the mask. As provided herein, the detector assembly can (i) measure the magnitude of the signal related to the fraction of beamlets that passes through at least a portion of the mask, and/or (ii) measure the magnitude of the signal related to the fraction of beamlets that is reflected from the mask, to inspect the mask.

In one embodiment, the beamlet supply assembly can direct a plurality of spaced apart, selectable beamlets simultaneously at the mask. In this embodiment, for example, the beamlet supply assembly can direct (i) at least approximately ten spaced apart beamlets simultaneously at the mask, (ii) at least approximately one hundred spaced apart beamlets simultaneously at the mask, (iii) at least approximately one thousand spaced apart beamlets simultaneously at the mask, and/or (iv) at least approximately ten thousand spaced apart beamlets simultaneously at the mask. In this embodiment, each of the beamlets can be shaped.

As provided herein, for example, the plurality of spaced apart beamlets can be organized (i) in a pattern that is substantially similar to at least a portion of one of the desired patterns, (ii) in a pattern that is substantially similar to at least a portion of the desired transparent pattern, and/or (iii) in a pattern that is substantially similar to at least a portion of the desired opaque pattern.

The present invention is also directed to a mask inspected with the inspection system, an exposure apparatus that utilizes the mask, an object on which an image has been formed by the exposure apparatus and a semiconductor wafer on which an image has been formed by the exposure apparatus. Further, the present invention is also directed to a method for manufacturing an inspection system, a mask, and/or an exposure apparatus and a method for making a device and semiconductor wafer utilizing the exposure apparatus.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1A is a partially pictorial, partially schematic diagram of an inspection system having features of the present invention;

FIG. 1B is a partially pictorial, partially schematic diagram of an embodiment of an inspection system having features of the present invention;

FIG. 2 illustrates a beamlet shaping section of the inspection system shown in FIG. 1B;

FIGS. 3A and 3B illustrate a beamlet source including a plurality of sources of beamlets;

FIG. 4 illustrates a cross-section of a portion of a multi-aperture array and beamlets as they pass through apertures in the multi-aperture array;

FIG. 5A is a plan view of a portion of a first multi-aperture array;

FIG. 5B is a plan view of a portion of a second multi-aperture array;

FIGS. 5C-5I illustrate some of the resultant cross-sectional shapes of beamlets that are obtainable when the beamlets emerging from apertures in the first multi-aperture array are superimposed on apertures in the second multi-aperture array;

FIG. 6 is a cross-sectional view of a portion of a first embodiment of the active blanking aperture array (ABAA) and a portion of a shield for the active beam aperture array;

FIG. 7 illustrates the association of the blanker logic circuits with each aperture in the active blanking aperture array;

FIG. 8 illustrates the action of the deflection system acting to deflect the beamlets onto selected portions of the surface to be inspected;

FIGS. 9A and 9B illustrate portions of repetitive desired patterns that can be inspected by the inspection system;

FIGS. 10A and 10B illustrate the required relationship between the spacing of the beamlets and the pattern repeat distance on the surface to be inspected;

FIGS. 11A and 11B illustrate how the inspection system detects an opaque defect in a transparent region;

FIGS. 12A and 12B illustrate how the inspection system detects a transparent defect in an opaque region;

FIG. 13 is a graph that illustrates signals received by a detector assembly;

FIGS. 14A-14J illustrate beamlet-mask geometries that can occur during an inspection process pursuant to the present invention;

FIG. 15A is a graph that illustrates the fraction of a beamlet hitting a mask;

FIG. 15B is a graph that illustrates the fraction of a beamlet hitting a defect;

FIG. 15C is a graph that illustrates the number of beam flashes required for a measurement to exceed its average value by a specified number of standard deviations;

FIG. 15D is a graph that illustrates a means of distinguishing true defects from statistical fluctuations in detector signals;

FIG. 15E is a graph illustrating the dependence of the quantity f/δf on electron beam energy and the acceptance angle of the transmission detector;

FIG. 16 is a partially pictorial, partially schematic diagram of an embodiment of an inspection system having features of the present invention;

FIGS. 17A, 17B, and 17C are plan views showing the location of beamlets on the mirrors of a digital micromirror device;

FIG. 18 describes the functioning of a beamlet deflector; and

FIG. 19 is a side schematic illustration of an exposure apparatus having features of the present invention.

### DESCRIPTION

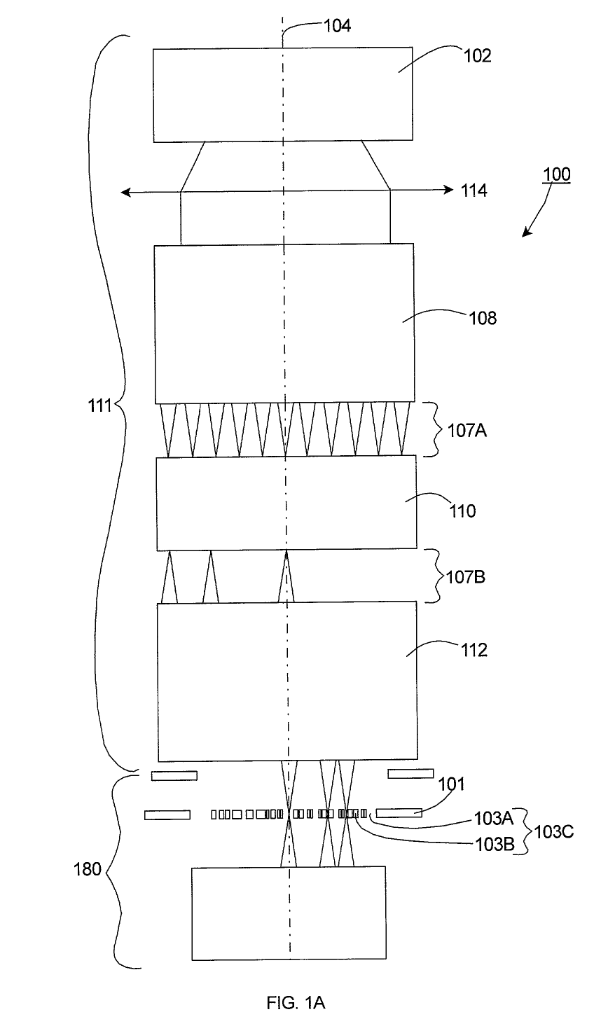

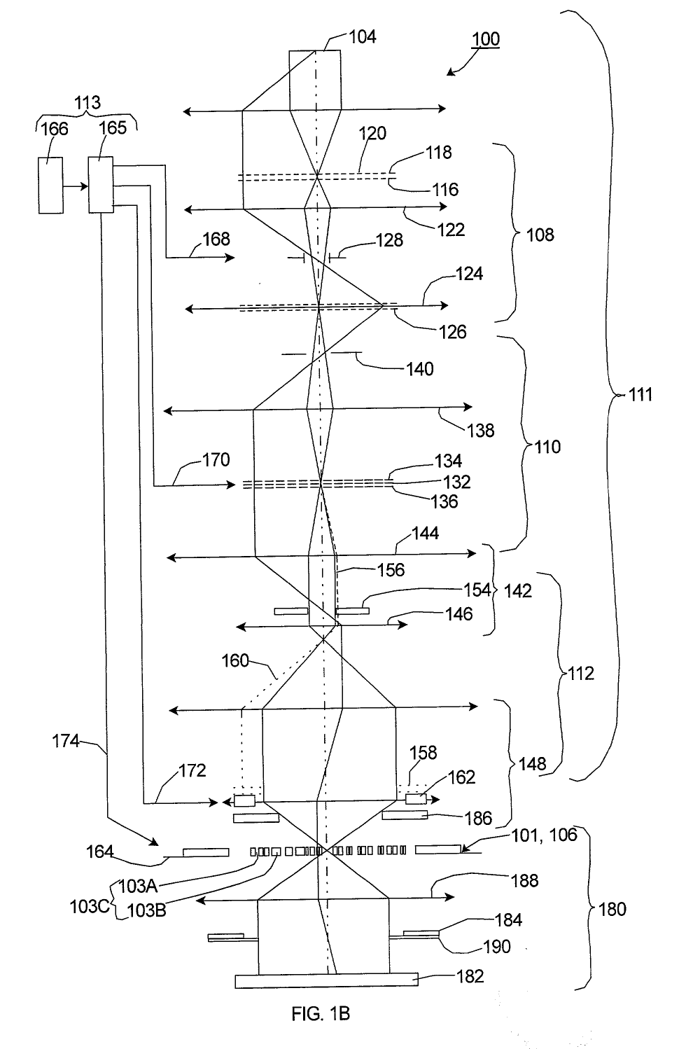

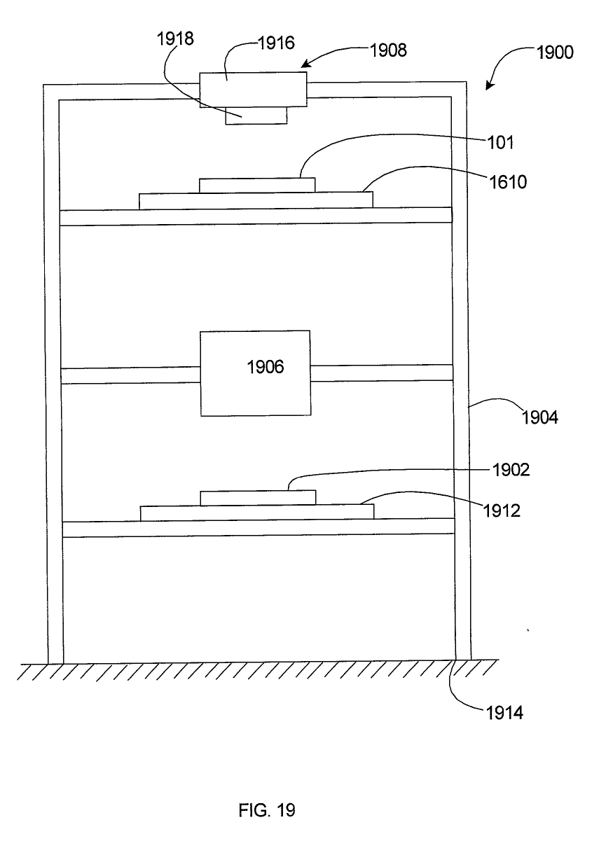

Referring initially to FIG. 1A, the present invention is directed to an inspection system 100 for inspecting a device such as a mask 101. The inspection system 100, for example, is useful for inspecting a mask 101 (also referred to as a “reticle”) that is employed with an exposure apparatus 1900 (illustrated in FIG. 19) during manufacturing of a semiconductor wafer 1902 (illustrated in FIG. 19).

The mask 101 illustrated in FIG. 1A can be a membrane stencil type mask. The mask 101 includes one or more patterns that are transferred as images to the wafer 1902. Accordingly, the design of the mask 101 will vary according to the desired design of the wafer 1902. The mask 101 includes a membrane having a plurality of actual transparent (open) areas 103A, a plurality of actual opaque areas 103B that are organized in an actual pattern 103C. In normal usage, a beam of radiation from the exposure apparatus 1900 illuminates selectively different portions of the mask 101 and exposes a photosensitive resist coating the top of the wafer 1902. With this design, the actual opaque areas 103B of the mask 101 correspond to the regions of the wafer 1902 that are not to be exposed and the actual transparent areas 103A of the mask 101 correspond to the regions of the wafer that are to be exposed by the exposure apparatus 1900.

Alternatively, for example, the mask 101 can be a photolithography type mask or a scattering contrast membrane mask for an electron beam projection lithography system. Still alternately, the mask 101 can be another type of device that includes one or more actual transparent areas 103A and/or one or more actual opaque areas 103B.

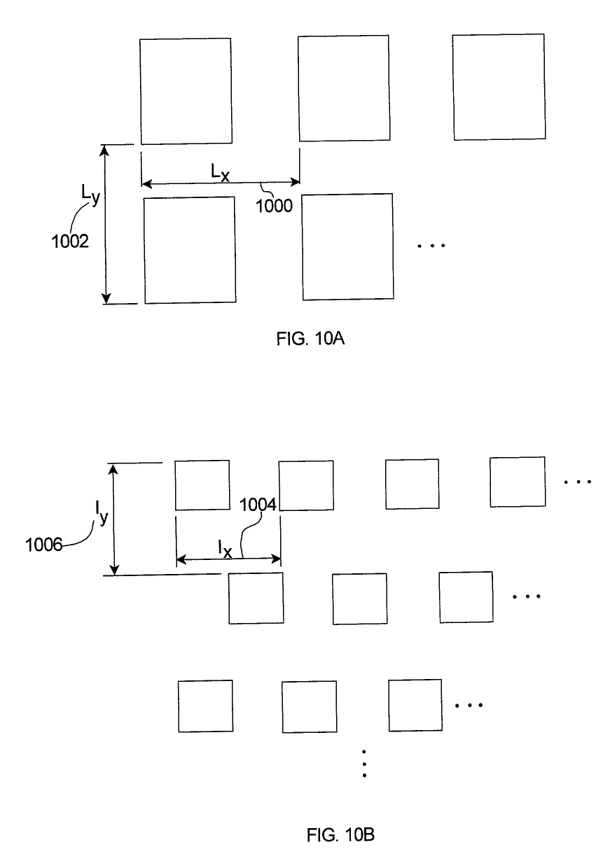

As an overview, the inspection system 100 can inspect the mask 101 to determine if (i) the actual transparent areas 103A of the mask 101 are similar to desired transparent areas 902 (illustrated in FIG. 9B) and/or (ii) the actual opaque areas 103B of the mask 101 are similar to desired opaque areas 900 (illustrated in FIG. 9A).

The inspection system 100 can include a beamlet supply assembly 111 and a detector assembly 180 to inspect the mask 101. The design of the components of the beamlet supply assembly 111 and the detector assembly 180 can be varied. For purposes of explanation, the beamlet supply assembly 111 is divided into a number of sections. At the top of FIG. 1A, the first section includes a source of illumination 102 and a lens element 114 that directs the illumination downwardly in a generally collimated beam parallel to a system axis 104 towards the mask 101. The collimated beam enters a beam shaping section 108 where the collimated beam is shaped into beamlets 107a having a selected shape. After being shaped by the beam shaping section 108, the beamlets 107a are directed into a beam blanking section 110 where selected beamlets are blanked so that they do not strike the mask 101. After the remaining beamlets 107b leave the beam blanking section 110, the beamlets are demagnified and directed onto the mask 101 by a lens group 112. After interacting with the mask 101, radiation from the beamlets is detected by the detector assembly 180 Depending upon the design of the system 100, the detector assembly 180 can detect both opaque and transparent defects in the mask 101. The design of the detector assembly 180 can be varied according to the design of the rest of the system 100. As provided herein, the detector assembly 180 can (i) measure the magnitude of the signal related to the fraction of beamlets that passes through at least a portion of the mask 101, and/or (ii) measure the magnitude of the signal related to the fraction of beamlets that is reflected from the mask 101. A control section 113 controls the overall operation of the inspection system 100.

The design of the source of illumination 102 can be varied. For example, the source of the illumination 102 can be a source of radiation or a source of charged particles such as an electron gun that emits electrons downwardly, generally parallel to the system axis 104. In the present application, an electron gun is used. The illumination is substantially collimated (made parallel) by a conventional electron lens element 114 acting as a condenser. Suitable lens elements are well known in the art.

The beam shaping section 108 shapes the beamlets. The design of the beam shaping section 108 can be varied. In the embodiment illustrated in FIG. 1B, the beam shaping section 108 includes a first multi-aperture array 116 and optionally, a shield 118 that protects the first multi-aperture array 116 from being struck by electrons. The first multi-aperture array 116 has M rows and N columns of apertures and each aperture has a first shape. The shield 118 also has M rows and N columns of apertures and each aperture has approximately the same shape as the apertures in the first multi-aperture array 116. However, the dimensions of the apertures in the shield 118 are slightly larger than the dimensions of the apertures in the first multi-aperture array 116 because the apertures in the multi-aperture array 116 define the shape of the beamlets. If a shield is utilized, the shield will absorb the majority of the electrons in the incident beam of electrons. The absorption of electrons by the shield causes the shield to heat, which in turn may cause the shield to distort. Because the apertures 120 in the shield 118 are larger than the apertures in the multi-aperture array 116, any distortion in the shield 118 should not affect the shape of beamlets transmitted through the apertures. The shield 118 may be constructed to absorb all of the incident electrons that are not passed through apertures 120 in the shield 118, or the shield 118 may be constructed to absorb only a portion of the energy of the incident electrons which decreases the required elevated temperature capability of the shield 118. In the latter case, the electrons that are not absorbed by the shield 118 will pass through the shield 118 and strike the underlying first multi-aperture array 116.

It should be appreciated that the electrons that pass through the shield material will have a substantially smaller energy. This requires that the first multi-aperture array 116 have the capability of withstanding an elevated temperature caused by the incident electrons that are not fully absorbed by the shield 118, as well as the incident electrons that pass through the shield apertures 120 and strike the first multi-aperture array 116.

A lens group, represented by lens elements 122 and 124, directs each of the beamlets towards the center of a corresponding aperture in the second multi-aperture array 126. The two multi-aperture arrays also lie in planes that are optically conjugate to one another. The second multi-aperture array 126 also has M rows and N columns of apertures that correspond to the M rows and N columns of the first multi-aperture array 116. The terms “that correspond” or “that corresponds” indicates that for every aperture in the first multi-aperture array, there is a corresponding aperture in the second multi-aperture array 126. However, the apertures in the second multi-aperture array 126 have a different shape. As discussed above, the electron lens group, represented by lens elements 122 and 124, directs each beamlet towards the center of the corresponding aperture in the second multi-aperture array 126. A deflector 128 deflects each beamlet a selected distance in a selected direction from the center of the corresponding aperture in the second multi-aperture array 126. As can be appreciated, all of the beamlets as they emerge from the second multi-aperture array can have the same selected cross-sectional shape.

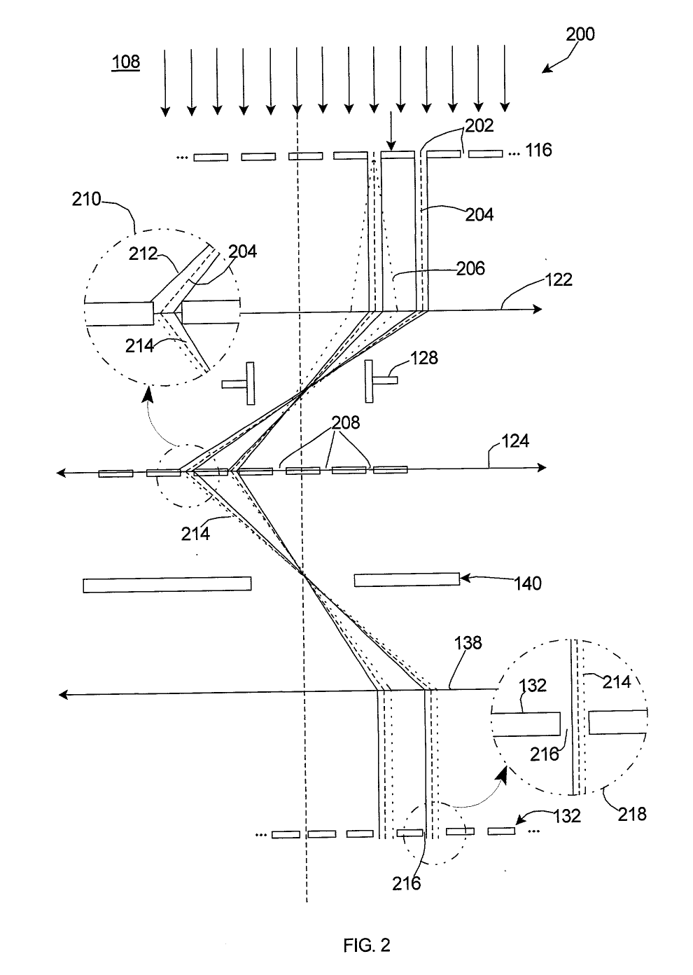

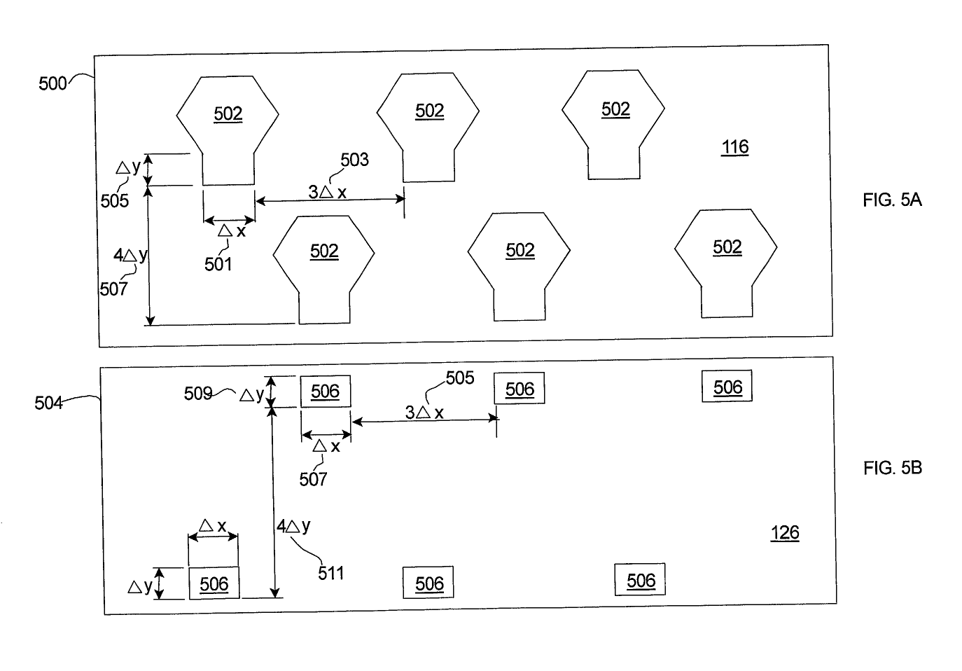

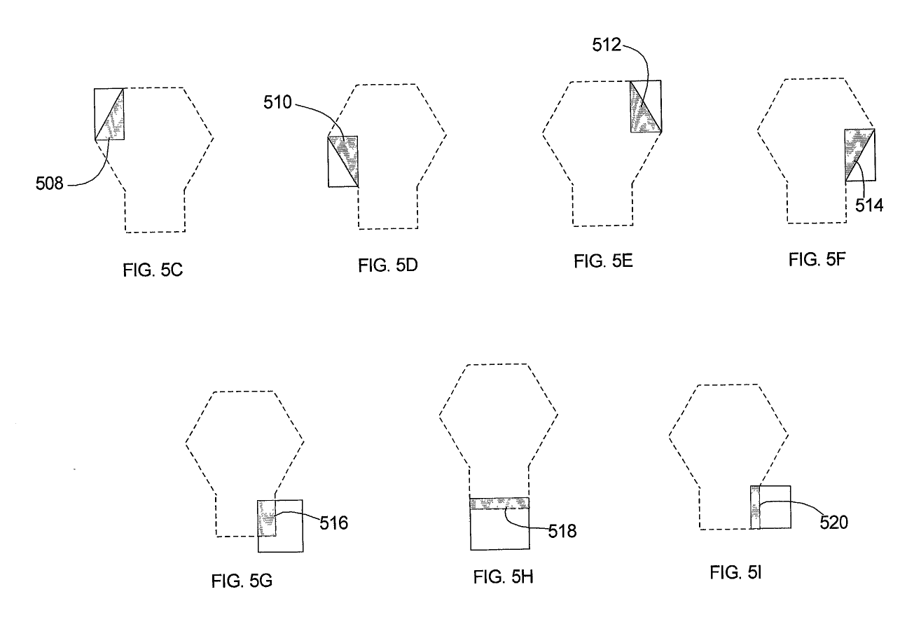

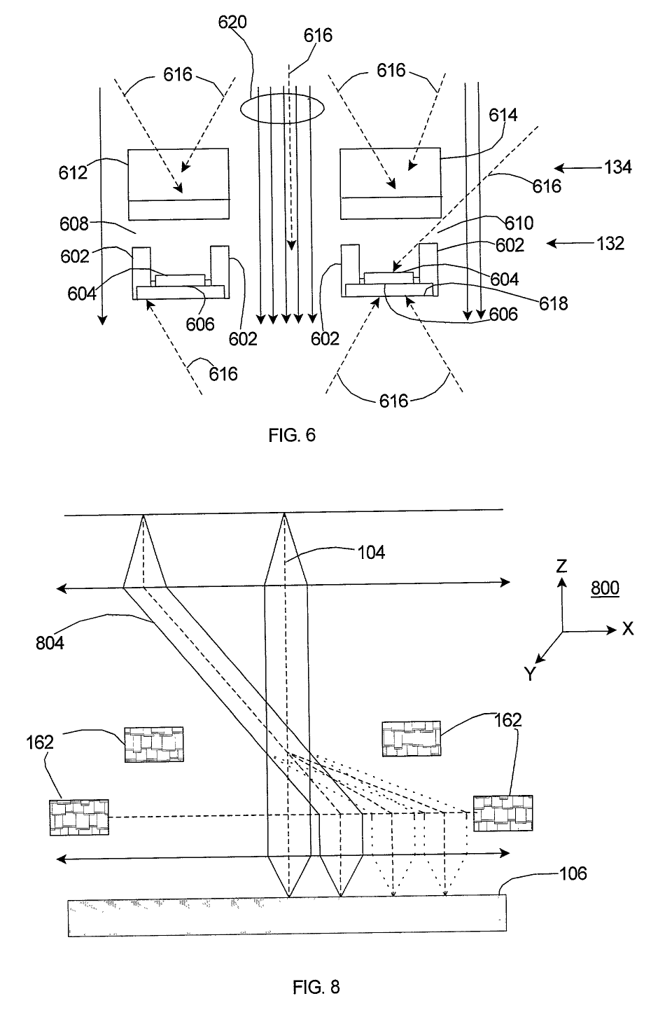

Referring to FIG. 2, the formation of the beamlets in the beam shaping section 108 is illustrated. The collimated beam 200 is incident on the first multi-aperture array 116. Those electrons passing through one of the apertures 202 of multi-aperture array 116 form a beamlet 204. The shape of the beamlet 204 will be discussed below in detail in conjunction with FIGS. 5A-5C. The beamlet 204 is re-imaged onto the second multi-aperture array 126 by the lens elements 122 and 124. For each aperture 202 in the first multi-aperture array 116 there corresponds an aperture 208 in the second multi-aperture array 126, so that each re-imaged beamlet from the first multi-aperture array 116 will pass through or partially pass through a corresponding aperture 208 in the second multi-aperture array 126.

It is noted that the angular distribution and the angular deflections of the lenses illustrated in FIG. 2 are shown much larger than they are in reality for purposes of illustration. A beam deflector 128 located between the first multi-aperture array 116 and the second multi-aperture array 126 deflects all of the beamlets 204 uniformly at the plane of the second multi-aperture array 126. The enlargement 210 shows a portion 212 of the deflected beamlet 204 being intercepted by an aperture 208 of the multi-aperture array 126. The interception of a portion 212 of the deflected beamlet 204 causes the shape of the beamlet 204 to change as it passes through the multi-aperture array 126. The details of the shape change of the beamlet 204 will be discussed below in conjunction with FIGS. 5C-5I.

Referring again to FIG. 1B, each beamlet, after passing through the beam shaping section 108, can be directed towards the beam blanking section 110. The beam blanking section 110 includes an active blanking aperture array (ABAA) 132, an upper shield 134 to protect the ABAA 132, and can include a lower shield 136 to further protect the ABAA 132. A lens element 138 focuses each beamlet on a corresponding aperture in the ABAA 132. The ABAA 132 has M rows and N columns of apertures. An x-ray baffle 140, which absorbs many of the x-rays generated in the column above it is located between the second multi-aperture array 126 and the lens element 138. The x-ray baffle 140 can be located at the back focal plane of the condenser lens element 138.

The active blanking aperture array (ABAA) is a rectangular array of apertures, each of which is bordered by electrostatic deflection plates. Each set of plates is activated by electronic circuitry located adjacent to the plates. When a set of plates is activated, the beamlet passing through the associated aperture is deflected away from the optical axis 104 of the column, so that it can intercept a contrast aperture 154 located beneath the beam shaping section 110 and thus be blanked, or prevented from reaching the mask 101. Row and column signal lines connected to the circuitry and controlled by control section 113 identify each deflector set to be activated by its row and column, so that the associated electronic circuitry can be activated and the associated beamlet can be blanked.

Alternatively the beam blanking section 110 may contain a passive blanking aperture array (BAA). This is similar to the ABAA, but the BAA has no local circuitry to activate the electrostatic deflection plates. Instead each set of deflection plates has a unique set of electrical lines connecting the plates with a remote dedicated electronic driver circuit, which is activated by the control section 113.

The reshaped beamlet 214 emerging from the second multi-aperture array 126 is re-imaged onto the plane of the ABAA 132 by the lens elements 124 and 138. For each reshaped beamlet 214 emerging from an aperture of the second multi-aperture array 126, there is a corresponding aperture 216 in the ABAA 132. As enlargement 218 illustrates, because a portion 212 of the original beamlet 204 was intercepted by the second multi-aperture array 126, the beamlet does not fill the corresponding aperture 216 of the ABAA 132. In fact, even if the full beamlet 204 was presented to the aperture 216 in the ABAA 132, the beamlet would not completely fill the aperture 216. The apertures in the first multi-aperture array 116, the second multi-aperture array 126 and the ABAA 132 are sized such that the apertures 216 in the ABAA 132 do not define the size or shape of the beamlet. Ideally, none of the electrons in the beamlet 214 strike the structure of the ABAA 132. The only function of the ABAA 132 is to blank selected beamlets.

It should be noted that with the present invention, the shape and number of beamlets directed at the mask 101 is selectable and can be easily and quickly varied. For example, the shape of the beamlets can be adjusted to be relatively small to inspect tiny transparent areas 103 or relatively large to inspect relatively large opaque areas 103B.

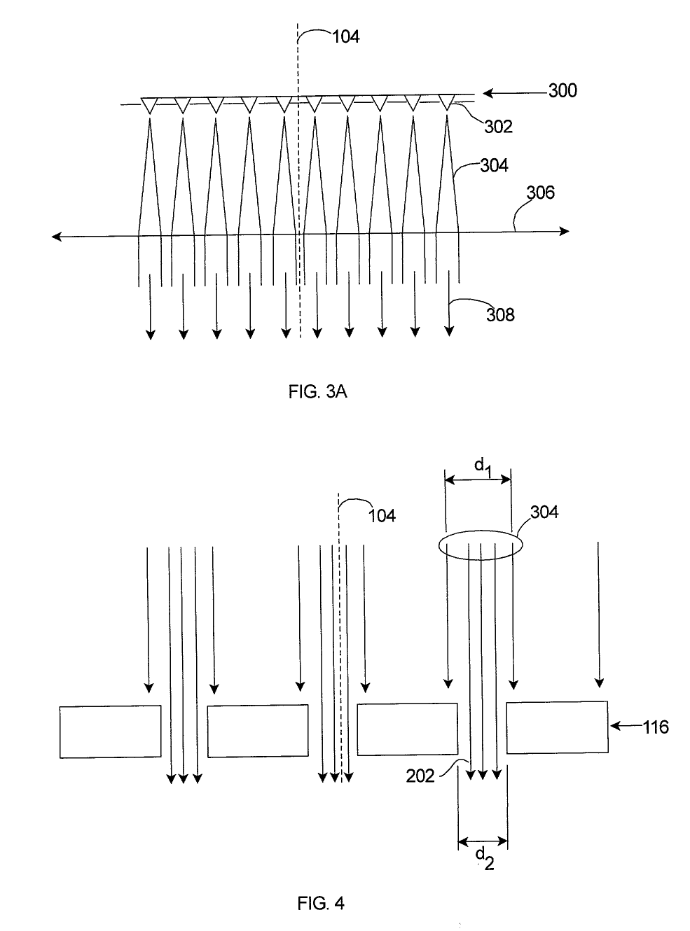

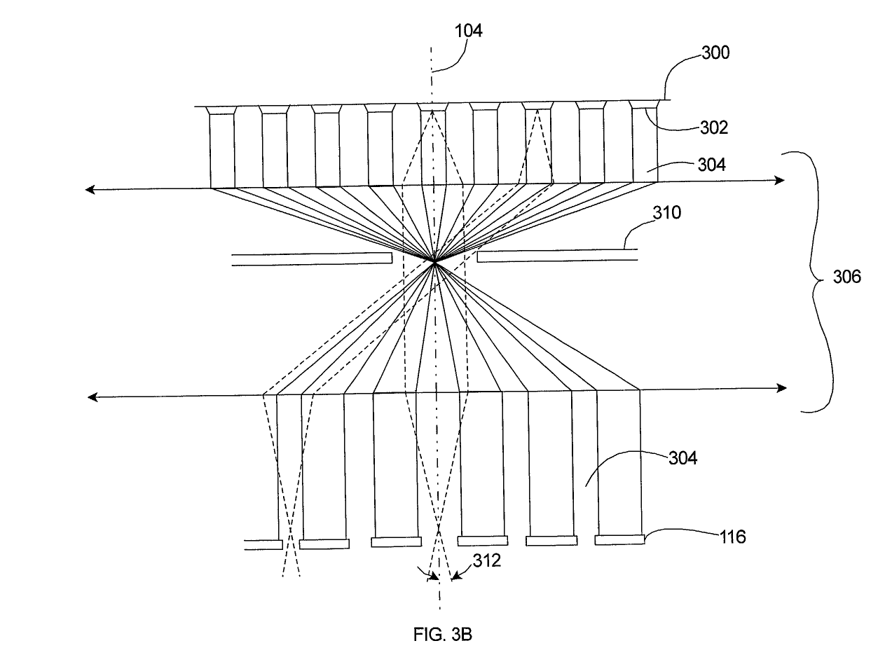

FIGS. 3A, 3B, and 4 illustrate an alternative source of beamlets to that illustrated in FIG. 1B. FIG. 3A illustrates a beam generator 300 having a plurality of sources 302 that are arranged in an array. The plurality of sources 302 generate a plurality of spaced apart beamlets 304 that are divergent and that are directed downwardly, in a direction generally parallel to the system axis 104. A lens group 306 acting as a matching array of condensers substantially collimates the beamlets 304 downwardly in a direction parallel to the system axis 104 as indicated by arrows 308.

FIG. 3B shows another embodiment of a multi-source beam generator. The multiple sources 302 are magnified appropriately, so that their spacing matches that of the apertures in the first multi-aperture array 116, using a lens doublet which makes the sources 302 conjugate with the multi-aperture array 116. An aperture 310 adjusts the angular range 312 of the electrons in the beamlets transmitted through the multi-aperture array 116.

FIG. 4 illustrates the formation of beamlets with uniform intensity from the beamlets formed in FIGS. 3A and 3B. In order for the beamlets 304 to have a uniform intensity over their entire cross-section, the size d₁ of each of the beamlets 304 generated by the plurality of sources 302 and collimated by the lens element 306 must be larger than the size d₂ of the individual apertures 202. If the plurality of sources 302 provide a relatively flat-topped distribution of electrons at the first multi-aperture array 116, electrons then strike the array 116 only in the vicinity of the apertures 202, and therefore the total number of electrons striking the first multi-aperture array 116 is reduced. In this embodiment, the multi-aperture array 116 must be capable of withstanding the elevated temperature caused by the incident electrons. However, in comparison with the beamlet source discussed above in conjunction with FIG. 1B, the smaller fraction of electrons incident upon the first multi-aperture array 116 will substantially reduce the required elevated temperature capability of the first multi-aperture array 116. Some possible examples of advanced cathodes that produce beamlets at each multi-aperture location are p-n junction arrays, a photocathode illuminated with a periodic array of light beams, and field emitter arrays. Field emitter sources have very small source size and thus may not fill the apertures of the first multi-aperture array 116. If the field emitter array is used with the condenser array 306, and the condenser lenses have substantial electron optical aberrations, the effective source size of the field emitters will be increased, and the field emitters can then fill the apertures in the first multi-aperture array 116.

Referring now to FIGS. 5A-5B, the relationship between one embodiment of the first multi-aperture array 116 and one embodiment of the second multi-aperture array 126 is illustrated. FIG. 5A is a plan view of a portion 500 of the first multi-aperture array 116 showing the shape of the apertures 502. The size and spacing of the apertures 502 in the X direction are indicated at 501 and 503. The size and spacing of the apertures 502 in the Y direction are indicated at 505 and 507. FIG. 5B is a plan view of a portion 504 of the second multi-aperture array 126 showing the shape of the apertures 506. The size and spacing of the apertures 506 in the X direction are indicated at 507 and 505 and the size and spacing of the apertures 506 in the Y direction are indicated at 509 and 511. It is to be understood that other shapes for each array as well as other spacings are comprehended by the present invention. The shapes shown in FIGS. 5A and 5B when combined, are capable of providing a majority of the shapes required for inspection of the mask 101.

The apertures in the multi-aperture arrays form a periodic lattice with repeat distance in the X direction of 4Δx and repeat distance in the Y direction of 4Δy. The image magnification between the two multi-aperture arrays is one for the present embodiment. If the magnification were M, then the aperture sizes and spacings in the second multi-aperture 126 would be multiplied by the factor M.

FIGS. 5C-5I illustrate the various shapes that can be achieved by superimposing a portion of the first shape 502 shown in FIG. 5A over a portion of the second shape 506 shown in FIG. 5B. The shaded portion in each diagram shown in FIGS. 5C-5I represents the resultant cross-sectional shape of the shaped beamlets that pass through the second multi-aperture array 126. The shaded portion 508 in FIG. 5C inspects a triangular area on the mask 101 (not shown in FIG. 5C), as do shaded portions 510 (FIG. 5D), 512 (FIG. 5E), and 514 (FIG. 5F). The size and orientation of the triangles 508, 510, 512, and 514 depend upon the direction and amount of deflection provided by the electron deflector 128. The shaded portion 516 (FIG. 5G) inspects a square or a rectangular area on the mask 101. The size of the square 516 can be selected by varying the direction and the amount of deflection provided by the electron deflector 128. The size of the square 516 can be as large as the aperture 506 (FIG. 5B) which in this case is the same size as the lower portion, indicated at 501, (FIG. 5A) of the aperture 502. The shaded portion 518 (FIG. 5H) inspects a horizontal rectangular area on the surface to be inspected 106 and the shaded portion 520 (FIG. 5I) inspects a vertical rectangular area on the mask 101.

It can be seen from FIGS. 5A and 5B that the aperture 502 in the first multi-aperture array 116 has five times the area of aperture 506 in the second multi-aperture array 126. However, alternate sizes and shapes are possible.

Because only a small fraction of the electrons in the incident beam (approximately 5/16) pass through the apertures, the majority of the electrons strike the first multi-aperture array 116. For example, if the maximum beam current at the mask 101 for inspection is required to be approximately 5 microamps, the beam current at the first multi-aperture array 116 must be no more than approximately 80 microamps. The difference between these values represents the amount of beam current deposited on the multi-aperture arrays under the condition of maximum beamlet size. At 20 kV this amounts to a power dissipation of 1.1 watts in the first multi-aperture array in the absence of a thermal shield, if the electrons are completely absorbed in the multi-aperture 116. This power level will heat the first multi-aperture array 116 to a high temperature.

If the first multi-aperture array 116 transmits 5/16ths of the beam, then the second multi-aperture array 126 intercepts from 4/16ths (beamlet 204 completely fills aperture 506 of the second multi-aperture array 126) to 5/16ths (beamlet 204 is deflected completely out of aperture 506) of the beam. This leads to maximum power dissipation of about 0.5 watts in the second multi-aperture array 126 in the absence of a shield. If a shield is present, the power dissipated is shared between the shield and the narrow regions of the multi-aperture array around the apertures that are not covered by the shield. In either case, it is necessary for either the second multi-aperture array 126 or the shield 130 to have the capability to withstand the elevated temperature that result from bombardment by the incident electrons.

Beam power dissipation in the various apertures and shields is an important design issue. Although they are also bombarded by X-rays generated by electron bombardment in other parts of the column, the x-ray intensities are too small to contribute any heating. Assuming that the beam current distribution at the first multi-aperture array 116 is uniform, only a small fraction of the electron current reaches the mask 101 to be inspected. In the absence of a shield 118, most of the beam current hits the first multi-aperture array 116 and is dissipated. As discussed above, for a maximum beam current at the mask 101 of 5 microamps, the beam current at the first multi-aperture array 116 is 80 microamps resulting in a power dissipation in the first multi-aperture array 116 of about 1.1 watts.

In a vacuum, cooling occurs only by conduction and radiation. If only radiation cooling occurs, and the area illuminated by the beam is approximately (4 mm)², then the temperature of the first multi-aperture array 116 could reach approximately 920 degrees celsius, assuming a thermal emissivity of 0.6 which is typical of silicon. The temperature of the melting point of silicon is 1410 degrees celsius.

A similar calculation for the second multi-aperture array 126 leads to a maximum power dissipation of 0.5 watts and a radiation limited temperature rise above ambient of approximately 700° C. If conductive cooling is also provided, these temperatures will be reduced.

These considerations illustrate the need for a thermal shield. The shield does not have to stop all electrons. If the shield absorbs 80-90% of the beam energy, the temperature of the multi-aperture array is greatly reduced. Any temperature rise in the multi-aperture arrays will cause thermal expansion, leading to an increase in the aperture dimensions and a displacement of their centers, as well as possibly thermal distortion. These changes could affect the inspection of the mask 101. However, the beamlets at the ABAA 132 can be demagnified by a large factor such as 100. Furthermore, there may be additional demagnification between the multi-aperture array 126 and the ABAA 132. This means that the effects of thermal expansion and distortions at the first and second multi-aperture arrays, 116 and 126, respectively, are reduced in magnitude by at least a factor of 100 at the device 101 to be inspected. Therefore, heating of the multi-apertures 116 and 126 is unlikely to affect the inspection of the device appreciably.

In the present embodiment the apertures in the second multi-aperture array 126 are assumed to be 10 μm squares, spaced apart by 40 μm vertically and horizontally. The dimensions and spacings of the apertures in the first multi-aperture array 116 may be inferred from the relations shown in FIGS. 5A and 5B. In the present embodiment the plane of the ABAA is conjugate to the planes of the first and second multi-apertures, and the optical magnification between the ABAA and the second multi-aperture is one, so the size of the ABAA square apertures is slightly greater than 10 μm, and their spacing is 40 μm vertically and horizontally. There are 100 rows and 100 columns of apertures, for a total aperture number of 10,000. Because each row of apertures is offset by one repeat distance from the row above and below, as shown in FIGS. 5A and 5B, the total extent of the beamlets on the ABAA is 4.04 mm×4.00 mm. If the system demagnification between the ABAA plane and the mask to be inspected is 100, then the maximum beamlet size at the mask will be 100 nm, and the beamlet spacing will be 400 nm horizontally and vertically. The beamlets cover a region of 40 μm square extent on the mask.

The operating conditions of the inspection system 100 will depend on its performance requirements. For example, throughput is proportional to, among other things, the beam current at the mask. However at high beam currents the beamlet resolution may be impaired by Coulomb interactions between the electrons in the beamlets. This may in turn reduce the detection sensitivity of the inspection machine 100 to small defects. One way to reduce the effects of Coulomb interactions is to increase the electron beam energy. However this increases the power deposition in the multi-aperture structures and other apertures in the electron column, exacerbating heating effects. In addition defect detection efficiency, to be described below, will in general depend on beam energy somewhat. Therefore the inspection machine operating conditions will represent a compromise among throughput, resolution, defect detection sensitivity, and heating effects.

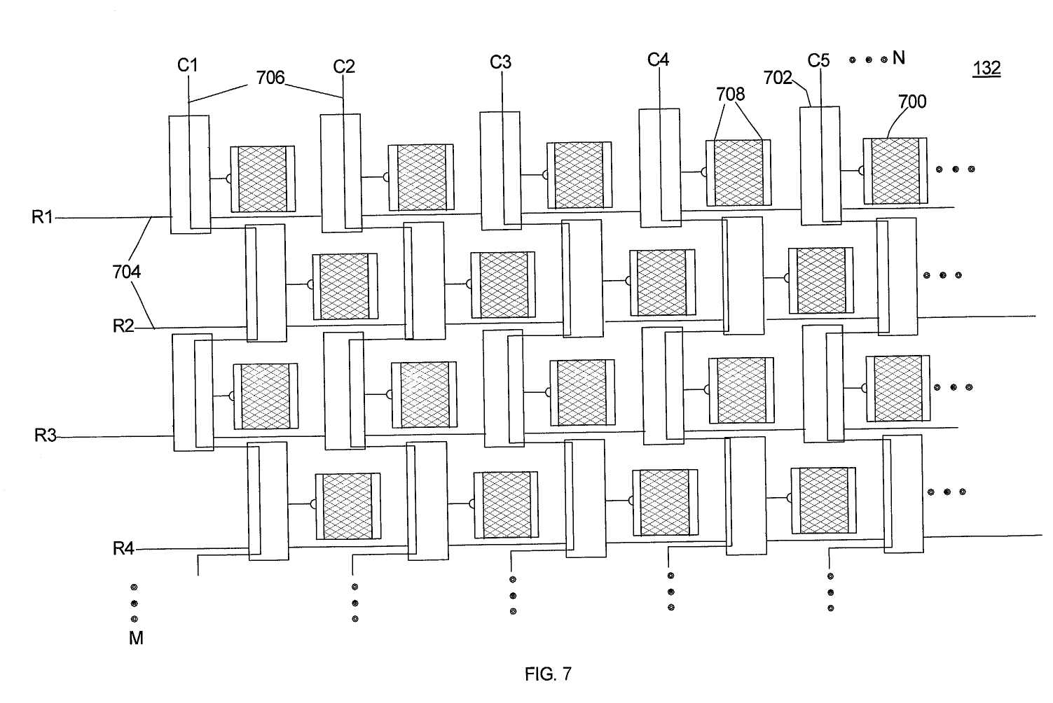

Referring to FIG. 6, a first embodiment of ABAA 132 includes deflectors 602 and electronic circuitry consisting of deflector logic and drivers 604 on an upper surface 606 of the ABAA 132 associated with each aperture in the ABAA 132. Two portions 608 and 610 of the ABAA 132 and two portions 612 and 614 of the upper shield 134 are illustrated. X-rays, indicated by the dotted lines 616, are shown impinging upon various structures including the portions of the ABAA 132 and the shield 134. The function of the shield 134 is to protect the electronic circuitry 604 of the ABAA 132 from being struck and damaged by the x-rays generated in structures in the inspection system upstream from the shield 134. As is indicated, the shield 134 protects the ABAA 132 from being struck by a majority of the generated x-rays with only a few x-rays striking the deflection logic 604. The function of the ABAA 132 is to blank selected beamlets. To “blank” a selected beamlet means that the selected beamlet does not reach the surface to be inspected. This is accomplished by the deflectors 602, which are controlled by the deflection logic 604. The deflectors 602 and deflection logic 604 deflect the selected beamlets to an extent that the selected beamlets strike a contrast aperture downstream from the ABAA 132.

The downstream structures that generate a majority of x-rays are the contrast aperture (to be described below) and the surface to be inspected 106. The second shield 136, as well as the upper shield 134, can be constructed of a first layer having a thickness t₁ of a low atomic number material, such as silicon that has an atomic number z of 14, that will minimize the generation of x-rays by impinging electrons, and a second layer having a thickness of t₂ of a high atomic number material, such as gold that has an atomic number z of 79 or tungsten that has an atomic number of 74. The first layer absorbs essentially all of the energy of the incident electrons, while the high atomic number material in the second layer provides strong x-ray absorption for those x-rays generated by the electrons striking the first layer as well as x-rays generated at other locations of the inspection system 100. An adequate thickness of the low atomic number layer t₁ is about 5-10 μm for 20 keV electrons, while an adequate thickness t₂ for the high atomic number layer is approximately 10-20 μm for x-rays with a maximum energy of 20 keV. It should be understood that the first layer is above the second layer for the upper shield, while it is below the second layer for the lower shield. Because a significant number of electrons are not expected to reach the ABAA from the multi-apertures or by backscattering from below, the low z layer in the shield may be mainly for structural purposes only to support the layer of high z material, which is to protect the deflector logic 604 from x-rays generated by electrons striking upstream or downstream structures. The beamlets are indicated at 620. The x-rays are indicated by dashed lines 616 and as illustrated can originate at various locations and have many directions. Additional shielding of the ABAA from x-rays generated from below is provided by the substrate base 618 of the ABAA.

The intensity of x-rays absorbed in the ABAA deflector logic is insufficient to cause any thermal damage. However they generate electrical charges which in principle could affect the electrical performance of the logic. Under the conditions in the inspection system column, x-ray exposure of the circuitry in the ABAA beam deflector logic 604 will not cause single beamlet blanking errors, which could create errors in the inspection of the device. The reason is basically that a photoelectron from a single x-ray does not deposit enough charge within the active region of a circuit to change its logic state. A large number of such events are required, and the periodic resetting of the logic circuits during inspection prevents accumulation of appreciable amounts of charge. Instead, the x-rays will gradually change voltage levels in the circuitry by creating holes (from electron-hole pairs) which become trapped in the silicon oxide layers, until logic functions are affected over a period of time. Similar comments apply to the low intensity of scattered electrons, which may strike the ABAA 132.

Because it is virtually impossible to prevent every x-ray from hitting the deflector logic 604, the deflector logic 604 has a finite lifetime. Therefore, it may be desirable to utilize radiation hardening in the circuitry design to achieve a longer lifetime of the deflection logic 604. This technique is described in, for example, W. Dawes et al., “Hardening Semiconductor Components Against Radiation and Temperature,” (Noyes Data Corporation, 1988). For CMOS technology, it is possible to design circuitry to tolerate cumulative doses of at least 100 krad(Si), where 1 rad(Si)=0.01 J/kg of absorbed energy in silicon. For example, if 100 krad(Si) is assumed, for a lifetime of 1 year full time operation (1 year equals approximately 3.14E7 seconds), the instantaneous dose must be less than approximately 0.003 rad(Si)/sec. The design of the present invention is expected to reduce the x-ray dose well below this limit, providing a lifetime in excess of ten years. It is emphasized that the circuit properties change slowly over the lifetime of the circuit. Therefore periodic inspection of the inspection system properties can determine when an ABAA unit needs to be replaced, long before its performance is impaired.

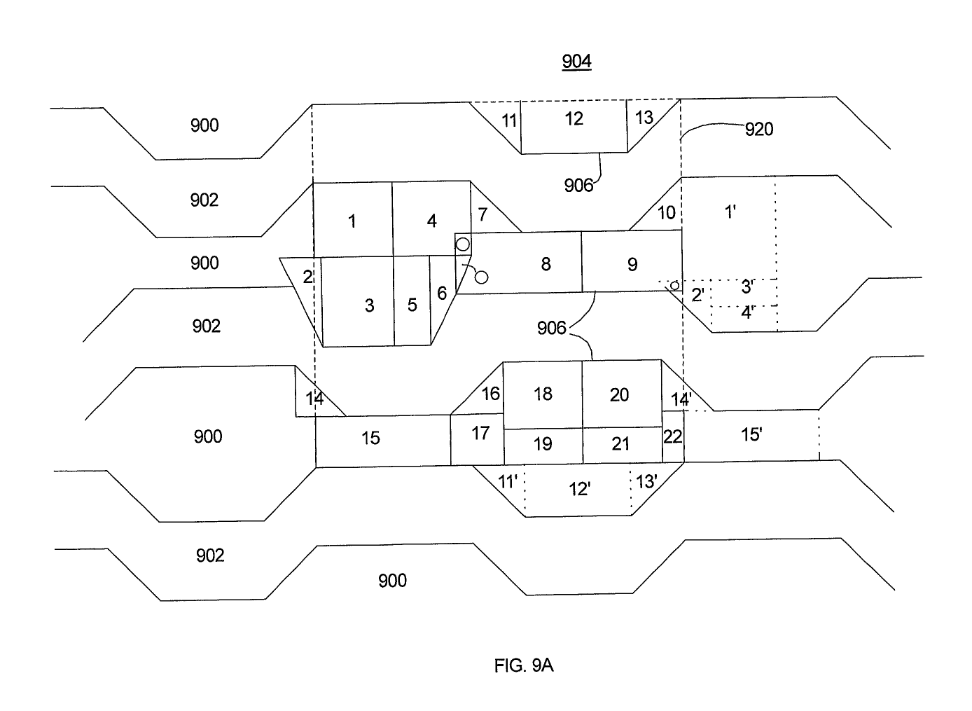

Referring to FIG. 7, a partial schematic of a portion of the ABAA 132 is shown. The ABAA 132 can have a large number of apertures, because locating the integrated logic unit 702 adjacent to each aperture minimizes the number of electrical connections that need to be routed through the aperture array. Each aperture 700 has the electronic logic unit 702 integrated into the aperture plate adjacent to each aperture 700. The ABAA 132 can be very large and can have on the order of 10⁶ apertures 700.

The large number of apertures in the ABAA 132 is made possible by locating the deflection logic units 702 adjacent to each aperture 700. The main reason is the simplification in connecting the deflectors to the pattern logic. In the above example, an array of 10⁶ apertures requires a total of only 2000 Row and Column lines to select each aperture uniquely. In contrast, in a passive BAA array, where each aperture is selected from a remote logic location, a total of about 10⁶ electrical connections are required to access all the apertures. Therefore, embodiments with a relatively small number of beamlets might advantageously use a BAA, while embodiments with a large number of beamlets would advantageously employ an ABAA.

The integrated electronic logic unit 702 could consist of a simple gate to turn on the associated deflectors to deflect the beamlet as it passes through an associated aperture. However, if a simple gate is used, time will be lost at the end of each inspection, while the next pattern logic is loaded into the gates. Because this delay decreases throughput, a memory unit can be included in the integrated electronic logic unit 702 so that the next pattern logic can be “latched” into the circuitry during the present inspection.

It is noted that the electronic complexity of the ABAA 132 is comparable to that of a 1 Mbit SRAM. In the case of the present invention, with regard to inspecting the mask 101, the minimum feature size of the electronic circuits can be approximately 1.2 μm if a CMOS design process is used. This feature size is readily available in existing semiconductor manufacturing foundries. Therefore, manufacturability of the ABAA should not be an issue. The available space for electronic logic unit 702 is approximately 100 μm². The integrated electronic logic unit 702 allows rapid addressing and updating. Row and Column drives, 704 and 706, respectively, address each electronic logic unit 702. The integrated electronic logic units 702 control deflectors 708 in FIG. 7 adjacent to each aperture 700 and selectively deflect the beamlets as they pass through the associated apertures 700.

Referring again to FIG. 1B, the shaped beamlets that are not blanked are directed downwardly towards the surface to be inspected 106 by the electron lens group 112 that demagnifies and focuses the shaped beamlets onto the surface to be inspected 106. The lens group 112 includes a first symmetric magnetic doublet 142 that includes a first lens element 144 and a second lens element 146. The properties of the symmetric magnetic doublet are described in a paper by M. B. Heritage, Journal of Vacuum Science Technology 12, 1135 (1975). The lens group 112 also includes a second symmetric magnetic doublet 148 that includes a first lens element 150 and a second lens element 152. A contrast aperture 154 is shown disposed at the crossover plane of the first symmetric magnetic doublet 142. The purpose of the contrast aperture 154 is to absorb the beamlets that have been blanked by the ABAA 132. The dashed line 156 represents the beamlets that have been blanked.

Also shown is an alternative location at the crossover plane of the second symmetric magnetic doublet 148 for a contrast aperture 158. The dotted line 160 represents the path of the beamlets that have been blanked and which are not absorbed until they strike the contrast aperture 158. The positioning of the contrast aperture 158 at the crossover of the second symmetric magnetic doublet 148 helps to prevent the x-rays generated by the electrons striking the contrast aperture 158 from reaching the deflection logic 604. Because the contrast aperture 158 eliminates the blanked electrons from the beam, its location may affect the magnitude and nature of Coulomb interactions between the electrons, which can cause both image blurring and distortion of the inspection beamlets.

An electromagnetic deflection system is shown at 162 that acts to move the beamlets over the surface to be inspected 106. The mask 101 is mounted on a moving stage 164. The design of the moving stage 164 can be varied. A control section is shown at 113. The control section 113 includes controller circuit 165 that is controlled by a central processing unit (CPU) 166. The controller circuit 165 is shown having an input 168 to the deflector 128, an input 170 to the ABAA 132, an input 172 to the deflection system 162, and an input 174 to the moving stage 164.

An inspection pattern (also referred to as the “desired pattern”) is created by the beam shaping section 108 and the blanking of selected beamlets is done at the ABAA 132. The inspection pattern is demagnified by a large amount, M=100-200, and projected onto the surface to be inspected 106. Despite the large demagnification, the inspection size at the surface to be inspected 106 is relatively large because the array is large and can be on the order of 1000 rows and 1000 columns. In one embodiment, there are 100 rows and 100 columns, and the apertures in the ABAA 132 are large enough to permit beamlet sizes as large as 10 μm. Assuming a system demagnification of 100, this allows the maximum field at the mask to be inspected 106 to be approximately 40 μm square.

Because the apertures in the ABAA 132 are separated by spaces, the corresponding beamlets on the surface to be inspected 106 are also separated by spaces. These spaces are filled in to make the complete pattern by deflecting the beamlets with deflectors 162 located in the lens group 112. The maximum deflection required is the separation between adjacent beamlets. For example, for the multi-aperture array geometries shown in FIGS. 5A and 5B, the spaces between beamlets on the surface to be inspected could be completely covered by a total of 16 exposures, or shots, (including the initial shot). For a more complicated pattern, different shaped beams, and different patterns of blanked apertures at the ABAA 132, would in general be associated with the settings of the deflectors 162. Between each shot the pattern in the ABAA is updated if necessary. The total number of shots required is, in general, pattern dependent and may exceed 16 for sufficiently complicated patterns. After complete inspection of the 40 μm square field, the pattern in the ABAA is quickly updated, and the new pattern is directed to an adjacent area of the surface to be inspected 106 using a deflection strategy such as a moving objective lens (MOL) to maintain image quality. The large deflections possible with a MOL or equivalent technique assists in attaining high throughputs. Appropriate motions of the mask stage are also required for complete inspection of the mask.

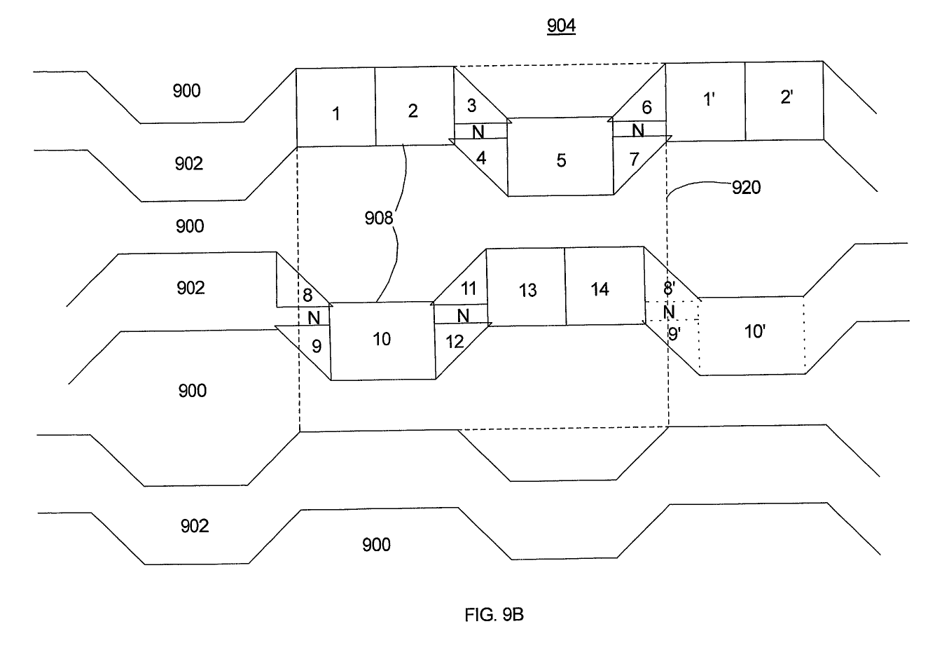

Referring to FIG. 8, the deflection system can be an MOL system utilized to move the image on the surface to be inspected 106. The optical elements required to effect the MOL are not shown, however, such systems are known in the art. The coordinate system is shown at 800. The axis of the system 104 is in the z direction, the beams 804 are deflected in the x direction and the surface to be inspected 106 moves in the y direction. As discussed above, the control section 113 provides control signals to the deflection system 162 and the stage upon which the surface to be inspected 106 is mounted.

FIGS. 9A and 9B illustrate an example of repetitive areas of a desired pattern 904 having (i) a plurality of desired opaque areas 900 which are inspected by a sequence of beamlet exposures 906 (numbered from 1 to 22 in FIG. 9A), and (ii) a plurality of desired transparent areas 902 which are inspected by a sequence of beamlet exposures 908 (numbered from 1 to 14 in FIG. 9B) using the inspection system 100 of the present invention. The areas shown in FIGS. 9A and 9B represent desired patterns for a particular mask. For example, the patterns shown could represent data lines in a DRAM. FIGS. 9A and 9B are meant to imply that the sequence of beamlet exposures identified by the unprimed numbers repeats many times in both the X and Y directions. In this example, the basic desired pattern area is inspected with a single beamlet, and the spacing of the beamlets is adjusted to the repeat distance of the basic desired pattern. The advantage of this embodiment is based on the high frequency of periodic, repetitive features in IC masks.

The rectangle 920 formed by dashed lines in FIGS. 9A and 9B represents the repeat distance of the beamlets in the X and Y directions. This is adjusted to the repeat distance of the mask pattern 904. The adjustment requires: 1) appropriate dimensional changes to multiapertures 116 and 126, and ABAA 136; or 2) a change in the lens group 112 magnification; or 3) a combination of the two.

In FIG. 9A a portion 906 of the opaque mask pattern 900 is inspected with a sequence of 22 exposures by a beamlet of appropriately adjusted shapes and sizes to reveal defects within the opaque regions 900. Note that regions labeled “O” represent areas where adjacent beamlets overlap, so that the region is exposed twice or more. This practice allows the number of beamlet exposures to be reduced. In FIG. 9B a portion 908 of the transparent mask pattern 902 is inspected with a sequence of 14 exposures by a beamlet of appropriately adjusted shapes and sizes to reveal defects within the transparent regions 902. Note that parts of the transparent region 908 labeled “N” do not have to be inspected, because they are remote from the opaque membrane of the mask and defects there can not exist. Accordingly, no beamlet exposure occurs in the regions labeled N, reducing the number of required beamlet exposures. Note also that some of the triangular beamlets overlap adjacent exposure fields for convenience. This practice allows the number of beamlet flashes to be reduced.

As provided above, the mask can include an actual mask pattern 103C having one or more actual transparent areas 103A and one or more actual opaque areas 103B. The beamlet supply assembly 111 directs one or more shaped beamlets toward the actual areas 103A, 103B of the mask 101. Each of the shaped beamlets has a beamlet characteristic that corresponds to a desired characteristic of one of the desired areas 900, 902. For example, each shaped beamlet can have (i) substantially the same or less than the cross-sectional size and shape as one of the desired areas 900, 902, (ii) substantially the same or less than the cross-sectional size and shape as one of the desired opaque areas 900, and/or (iii) substantially the same or less than the cross-sectional size and shape as one of the desired transparent areas 902.

The beamlet supply assembly 111 directs a plurality of spaced apart beamlets substantially simultaneously at the mask 101. For example, the beamlet supply assembly 111 can direct (i) at least approximately ten spaced apart beamlets simultaneously at the mask, (ii) at least approximately one hundred spaced apart beamlets simultaneously at the mask, (iii) at least approximately one thousand spaced apart beamlets simultaneously at the mask, and/or (iv) at least approximately ten thousand spaced apart beamlets simultaneously at the mask 101. Each of these beamlets can be shaped as described above.

As provided herein, for example, the plurality of spaced apart beamlets can be organized (i) in a beam pattern that is substantially similar to at least a portion of one of the desired patterns 906, 908, (ii) in a beam pattern that is substantially similar to at least a portion of the desired transparent pattern 906, and/or (iii) in a beam pattern that is substantially similar to at least a portion of the desired opaque pattern 908.

FIGS. 9A and 9B illustrate an example of repetitive areas of the mask 101 that can advantageously be inspected using the inspection system 100 of the present invention. In this example, the basic pattern area is inspected with a single beamlet, and the spacing of the beamlets is adjusted to the repeat distance of the basic pattern as described below. Thus, as the basic pattern is inspected, all equivalent patterns are simultaneously inspected by the corresponding beamlets, throughout the total inspection field of approximately 40 μm square. The sequence of inspections for the opaque pattern 900 in FIG. 9A is as follows: shapes labeled 1 are inspected first, then shapes labeled 2, then shapes 3 and so on until shapes 22 are inspected. Simultaneously, corresponding shapes are inspected in the other repetitive cells by their corresponding beamlets. This is illustrated by the shapes defined by dashed lines and labeled 1′, 2′, 3′, 11′, 12′, 13′, and 15′, in FIG. 9A, in reference to shapes 1, 2, 3, 11, 12, 13, and 15 in the basic pattern shown. A similar sequence occurs for the transparent pattern 902 in FIG. 9B. If there are regions in the total inspection field that don't contain this pattern, the corresponding beamlets are blanked. Those patterns would be inspected later, and the beamlets used to inspect the above repetitive patterns would then be blanked.

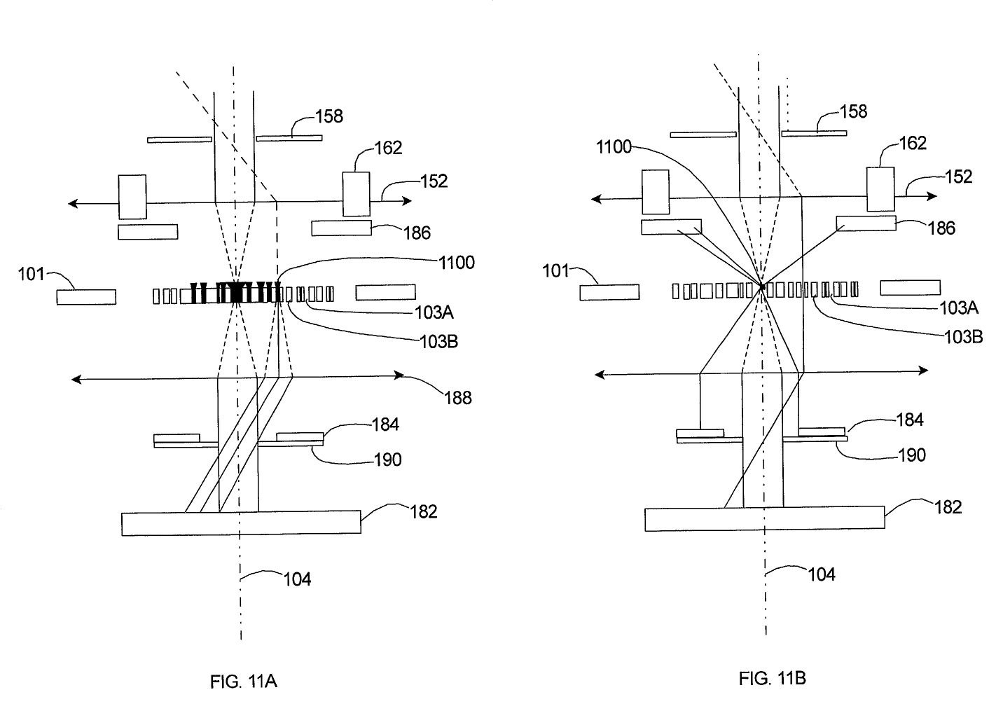

Referring to FIGS. 10A and 10B, there is illustrated the required relationship between the spacing of the beamlets and the pattern repeat distance on the surface to be inspected. FIG. 10A illustrates an example of repetitive pattern spacing Lₓ 1000 in the horizontal direction and L_{y} 1002 in the vertical direction on the surface to be inspected 106. FIG. 10B illustrates the spacing between adjacent beamlets passing through a multi-aperture array as measured on the surface to be inspected, that is, the beamlet spacing has been demagnified by the lens group 112. The horizontal spacing is shown as Iₓ 1004 and the vertical spacing is shown as I_{y} 1006.

While any pattern can, in principle, be inspected using the concepts of this invention, it is most advantageously used to inspect repetitive patterns so that as many of the beamlets as possible can be utilized simultaneously for each inspecting shot. This requires that the spacing between the beamlets have a simple integral relationship with the pattern repeat distance on the substrate being inspected. Examples of pattern repeat distances might be the spacing of repeating memory cells and related structures on a DRAM. In particular, if the spacing between adjacent beamlets on the substrate are Iₓ and I_{y} in the X and Y directions respectively, as shown in FIG. 10B they should be related to the pattern repeat distances Lₓ and L_{y}, as shown in FIG. 10A, as follows: Lₓ=mlₓ and L_{y}=nl_{y}, where m and n are integers. In the present embodiment m and n are generally equal to 1. This relationship may be achieved by: installing an appropriate ABAA array (and corresponding multi-aperture arrays) with the appropriate spacing for the desired cell pattern; and/or by adjusting the electron optical demagnification between the ABAA 132 and the mask 101.

In the event that the pattern to be inspected is not highly repetitive, the above strategy can not apply. However, if the pattern is designed on a uniform grid, based on the minimum feature size of the pattern or some smaller distance, a useful relation can again be established between this size and the ABAA aperture repeat spacing. If the size of the uniform grid on the pattern is given by Gₓ and G_{y} in the x and y directions, then the ABAA aperture repeat spacings, measured at the surface to be inspected 106, should satisfy the relations Iₓ=jGₓ and I_{y}=kG_{y} where j and k are integers.

The advantage of these conditions is that the field covered by each beamlet is referenced to the same coordinate system, and all features lie on the same grid. Therefore, even though each field may have different patterns, parts of some of the features are likely to lie at the same grid locations for a number of different fields. All of these parts can be inspected simultaneously with beamlets unblanked only for those fields, and with the beamlets deflected and shaped appropriately for the particular feature part and its location. The presence of such common features or parts of features reduces the number of consecutive beam flashes required to inspect the non-periodic parts of the mask. On the other hand, if the patterns in the fields are very dissimilar, requiring exposures with only a small number of beamlets unblanked, the statistical accuracy required to identify an opaque mask defect is reduced (since the defect signal is associated with a single beamlet, while the “background” signal comes from all the other unblanked beamlets). Therefore the signal integration time which determines the statistical accuracy can be reduced. This will partially offset the extra time required to inspect the non-periodic regions of the mask.

Furthermore, although for relatively sparse patterns, where the mask openings represent a small fraction of the field areas, and by assumption the features in the different beamlet fields might not overlap much, leading to a relatively small number of unblanked beamlets, by the same token a relatively large proportion of the fields should have common areas where the mask membrane is present. Therefore inspection of clear defects in the mask membrane should proceed with relatively little increase in inspection time.

Basically the same argument can be made for the complementary case where the openings in the mask membrane represent a relatively large fraction of the field area.

In the case of repetitive patterns, such as DRAMs, the repetitive cells would be positioned according to the uniform grid. Consequently, it can be seen that the two relations discussed above which relate the ABAA aperture spacing to pattern dimensions are self-consistent.

The method and system of the present invention can provide an improved throughput in comparison to prior art methods and systems. The high throughput can be achieved in embodiments having the capability of having a large array of identical beamlets of variable shape that are shaped by two multi-aperture arrays each having different shaped apertures. An active blanking aperture array (ABAA) 132 has deflection logic associated with each aperture, which allows the ABAA 132 to be large and can be on the order of 1000 by 1000 apertures. The deflection logic associated with each aperture, which is susceptible to radiation damage, is protected by the design of the system. In addition to the availability of radiation hardening of the deflection logic, shields and baffles can be used to shield the deflection logic from x-rays generated within the inspection system. The design of the system provides that the beamlets are formed upstream from the ABAA 132 and therefore there are no unscattered electrons that should strike the ABAA 132.

It will also be recognized that the design of the inspection system 100 provides a relatively long lifetime for the radiation sensitive circuitry of the ABAA within the inspection system 100. The high throughput decreases the cost of the inspecting masks 101 with the system. The different shapes of the beam shaping multi-apertures provide maximum flexibility in inspecting various shapes on the mask. The deflection logic includes a buffered latch, which allows the next pattern to be loaded into the deflection logic which the current pattern is being inspected.

In the embodiments illustrated herein, each multi-aperture array 116, 126 contains an array of identical apertures in 1:1 correspondence with the ABAA blankers. The two aperture arrays 116, 126 are optically conjugate to one another and to the ABAA. A deflector between them allows the imaged pattern of the beamlets from the upstream one to be offset on the apertures of the downstream one. This allows both the size and shape of the beamlets transmitted through the second aperture array 126 to be controlled. However for a given deflector condition, all the beamlets have the same size and shape. By properly breaking up the desired pattern on the mask, a large number of beamlets can be used to inspect the mask simultaneously, thereby enhancing the throughput. Thus, patterns of arbitrary size and complexity can be inspected with this system 100. The greatest advantage of this technique is realized when the pattern is highly repetitive, as for example for a DRAM.

For embodiments with a relatively small number of beamlets a BAA may be appropriate rather than an ABAA.

Referring back to FIG. 1B, the inspection system 100 includes the detector assembly 180 that is used in conjunction with the beamlets supply assembly 111 to detect defects in the mask 101. Depending upon the design of the system 100, the detector assembly 180 can detect both opaque and transparent defects in the mask 101. The design of the detector assembly 180 can be varied according to the design of the rest of the system 100. As provided herein, the detector assembly 180 can (i) measure the magnitude of the signal related to the fraction of beamlets that passes through at least a portion of the mask, and/or (ii) measure the magnitude of the signal related to the fraction of beamlets that is reflected from the mask. In the embodiment illustrated in the Figures, the detector assembly 180 includes a first detector 182, a second detector 184, and a third detector 186.

Further, the detection assembly 180 can include an electron lens 188 and a contrast aperture 190 positioned below the mask 101. The design of the electron lens 188 and the contrast aperture 190 can be varied. The design of the electron lens can be similar to the projection lens positioned just above the mask 101.

For the stencil mask 101, the opaque regions 103B are thick enough to scatter electrons efficiently onto the contrast aperture 190 that is in the front focal plane of the electron lens 188. Further, the transparent regions 103A do not scatter electrons. The inspection system 100 utilizes the basic contrast mechanism employed by these masks.

The first detector 182 is centered on the system axis 104 in or beyond the front focal plane of the electron lens 188 and can detect non-scattered electrons from the transparent areas and defects of the mask 101. In this detection mode, the contrast aperture should be chosen to intercept a scattered electron angle larger than the numerical aperture (NA) of the e-beam. If the focal length of the lens is F, then the aperture radius should be larger than F×NA. A suitable first detector 182 is a scintillation detector or a semiconductor detector or a Faraday cup.

In the embodiment illustrated in the Figures, the second detector 184 is an annular shaped detector that is positioned and centered on the system axis 104. A suitable detector 184 is a scintillation detector or a semiconductor detector. The second detector 184 includes a detector opening and corresponding opening angle, measured from the plane of the mask, that is larger than that corresponding to the numerical aperture of the beam or the contrast aperture 190. The second detector 184 is located in the front focal plane of the electron lens 188. With this design, a signal will be present at the second detector 184 only when an opaque defect is present in the mask, and electrons scatter through angles larger than the detector opening angle.

The third detector 186 is a backscattered electron (BSE) detector that measures the amount of electrons backscattered from the mask. A suitable third detector 186 is a scintillation detector or a semiconductor detector.

The deflection system 162 deflects the beamlets across the mask 101, in order to increase throughput. If the beamlets land substantially vertically on the mask 101, the detector assembly 180 will function properly, without the need of additional deflectors below the mask 101, provided the contrast aperture 190 lies approximately in the front focal plane of the lens 188.

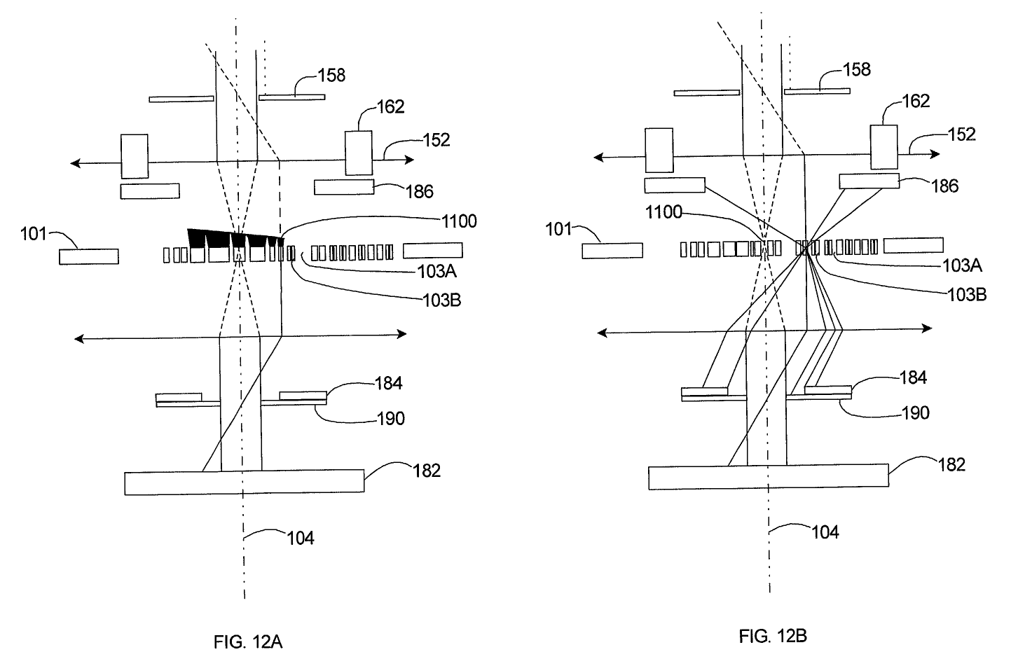

FIGS. 11A and 11B illustrate how the inspection system 100 detects an opaque defect in the transparent regions 103A of the mask 101. In FIG. 11A, the shaped beamlets 1100 are directed at the transparent regions 103A of the mask 101 with no opaque defect present. All electrons are transmitted into the first detector 182 without scattering. In FIG. 11B, the shaped beamlets 1100 are directed at the transparent regions 103A of the mask 101 with an opaque defect present. Because of the opaque defect in the transparent region 103A, the second detector 184 and the third detection 186 each receive a signal, and the magnitude of the signal in the first detector 182 is reduced.

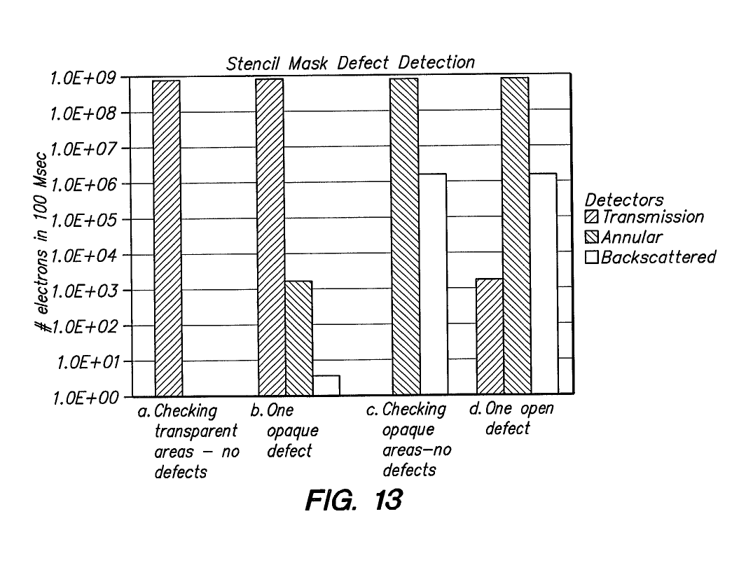

FIGS. 12A and 12B illustrate how the system 100 detects transparent defects in the opaque regions 103B of the mask 101. In FIG. 12A the beamlets 1100 are directed to opaque regions of the mask. The beamlets scatter in the mask membrane, producing signals in the second detector 184 and the third detector 186, as well as a relatively weak signal in the first detector 182. FIG. 12B illustrates that if the opaque region 103B includes a transparent defect then the signal to the first detector 182 is increased, and the signals to the second detector 184 and the third detector 186 are decreased. Even small defects in the mask, either opaque or transparent, will significantly change the signal received by each of the detectors 182, 184, 186 of the detector assembly 180. The fractional change depends on both the defect properties and the number of beamlets used to inspect the mask.

The mask pattern can be regarded as an array of pixels, the pixel size chosen small enough to allow all features of the mask to be represented by pixels without error. The inspection system 100 can be designed to inspect a large number of mask pixels simultaneously. The high throughput of this system 100 occurs because of the large number of mask pixels that can be tested simultaneously. Each ABAA aperture controls a variable shape beamlet, which might be a variable shaped square or rectangle or triangle. From conventional variable shape electron beam systems the dynamic range of the beamlet size in one dimension might be approximately 10:1. Thus a single ABAA aperture can inspect up to about 100 pixels on the mask 101 with each shot, assuming the minimum beamlet size to correspond to the pixel size. If there are N ABAA apertures, then up to 100N pixels may be inspected simultaneously.

Masks are presently inspected with single electron beam systems, typically using a gaussian shaped beam which inspects the mask one pixel at a time. Using an electrostatic deflection system, it typically takes about 10 nsec to acquire a statistically significant pixel signal. Assume, for example, that the ABAA based system collects data for 100 μsec at every main deflection setting. In that time, a single gaussian beam system could test 10,000 pixels. However this corresponds to only N≈100 ABAA apertures. As discussed below, the system 100 can probably employ 1000-10000 apertures or more in parallel, so throughput advantages of 10-100 or more may be possible.

Once a defect is detected, the number of beamlets is reduced until the location of the defective area of the mask 101 is determined unambiguously. In most cases, defect densities are quite low, so the effect on throughput should be quite limited.

Modeling Results

To quantify earlier comments about the effect of defects on the signal intensities at the three detectors, modeling studies were carried out to demonstrate the feasibility and sensitivity of this embodiment. The optimum use of the detector signals is also described.

Defect Signal Detection

The signals received by the detectors 182, 184, 186 for various types of defects were calculated using elastic and inelastic electron scattering cross sections from Soum et al (G. Soum et al, in Electron Beam Interactions with Solids, SEM Inc., 1982, 173). The collection efficiencies of the detectors 182, 184, 186 were then calculated from these cross sections and the solid angles assumed for the detectors 182, 184, 186. Backscattered electron yields were calculated from Sogard (M. Sogard, J. Appl. Phys. 51, 4417 (1980)).

Stencil Mask Signals—Ideal Case

Initially the beamlets were treated as ideal, with intensity distributions that fall off abruptly at the edges, i.e. the edgewidth of the beamlets is equal to zero. This is not realistic, but it serves to introduce the feasibility and properties of the inspection system 100. Below, the study is redone with beamlets having a finite edgewidth.

For the stencil mask 101, only two defects were considered: 1) an opaque defect in the transparent region 103A of the mask 101; and 2) a transparent (hole) defect in the opaque region 103B of the mask 101. The defect considered was a 50 nm square. For a 4× demagnification lithography exposure tool, this corresponds to a 12.5 nm defect imaged on the wafer. For the opaque defect in the transparent region 103A, it was assumed that the opaque defect had a thickness 0.1 μm, less than that of the membrane itself, which was assumed to be 1 μm. The maximum size of each beamlet was 0.5 μm. The beam current density was 0.1 A/cm². A total of 10⁴ ABAA beamlets and an average mask transparency of 0.5 were assumed, leading to a current at the mask 101, in the absence of defects, of 1.25 μA. The electron beamlet energy was 100 keV. For the case of an opening angle of 1 mrad at the contrast aperture 190, the above defects led to the currents in detectors 182, 184, 186 listed in Table 1:

TABLE 1

| | First Detector | Second | Third Detector |
|---|---|---|---|
| Condition | 182 | Detector 184 | 186 |
| One opaque defect | 1.25 × 10⁻⁶ | 2.3 × 10⁻¹² A | 5.0 × 10⁻¹⁶ A |
| Checking opaque | 8.3 × 10⁻¹⁸ | 1.2 × 10⁻⁶ | 2.5 × 10⁻⁹ |
| areas - no defects | | | |
| Opaque area - one | 2.5 × 10⁻¹² | 1.2 × 10⁻⁶ | 2.5 × 10⁻⁹ |
| transparent defect | | | |

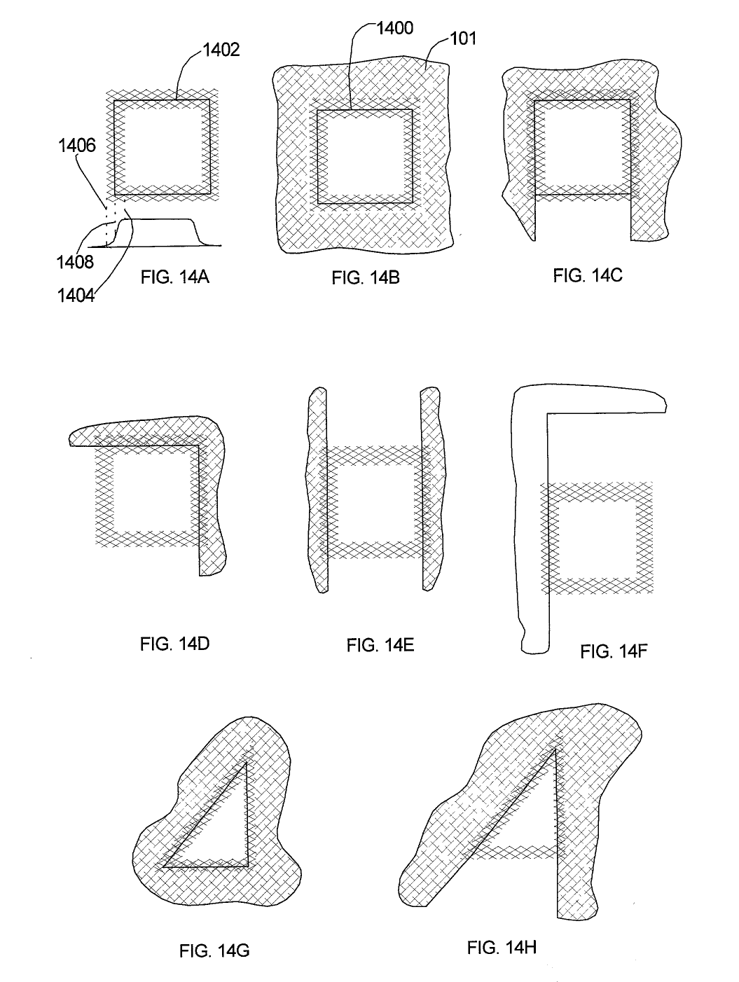

These currents were integrated for a total time of 100 μsec. The resulting signals received by the detectors 182, 184, 186 are summarized in FIG. 13. In FIG. 13, the black bar illustrates the signal received by the first detector 182, the gray bar illustrates the signal received by the second detector 184, and the white bar illustrates the signal received by the third detector 186. Note that the vertical axis is logarithmic. From FIG. 13, it is clear that even small defects can be easily detected from the relative sizes of the signals from the detectors 182, 184, 186. Furthermore, the number of beamlets directed towards the mask 101 from the beamlet source 102 can be increased to increase the throughput of the inspection system 100.

It should be noted that the detector signals will vary according to the characteristics of the defect and the characteristics of the one or more beamlets.

Stencil Mask Signals—Realistic Case

In reality, the beamlets from the inspection system 100 have a finite edgewidth. The edgewidth comes from both geometric aberrations in the electron optics and from Coulomb interactions between electrons in the beamlets. This means that in general, part of the edges of a beamlet illuminating a transparent area 103A in the mask 101 will intercept the edges of the opaque area 103B around the transparent area 103A, and part of the edges of a beamlet illuminating an opaque area 103B of the mask 101 will pass through transparent areas 103A next to the opaque region 103B. Since those fractions of the edges of the beamlets produce signals in the detectors 182, 184, 186 identical to that of a defect, the true defect signal will be degraded and the defect sensitivity of the inspection reduced.

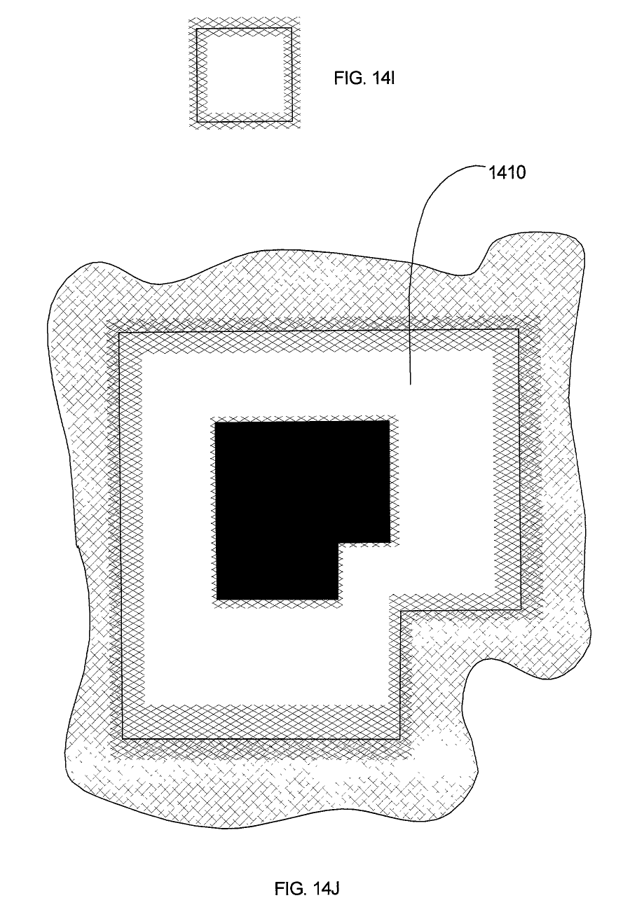

FIGS. 14B-14H illustrate some of the beamlet-mask geometries that can occur during inspection. FIG. 14A illustrates a square beamlet with the finite edgewidth delineated by a cross hatch pattern. For the case of a square or rectangular beamlet probing transparent areas 103A of the mask 101 the edges on all four sides of the beamlet 1400 may slightly overlap an opaque area 103B, or only three sides, or two sides, or one side (FIGS. 14B-14F). Similarly, for the case of a triangular beamlet probing transparent areas 103A of the mask 101 the edges on all three sides of the beamlet 1400 may slightly overlap an opaque area 103B, or only two sides (FIGS. 14G, 14H). (The case of a triangular beamlet overlapping only a single edge is not expected to be very useful). For large transparent regions 103A, it should be sufficient to scan only the perimeter of the transparent region 103A, since an opaque defect will not occupy the central portion of the transparent region 103A without a detectable connection to the perimeter. This is illustrated in FIGS. 14I and 14J, where FIG. 14I shows the beamlet, and FIG. 14J shows the total region 1410 covered by the beamlet as it is scanned over the periphery of the pattern. This may save some inspection time, if there are relatively large transparent areas 103A on the mask 101. In this mode typically only one or two sides of the beamlet overlap the pattern edges. Similar situations will occur when scanning opaque regions 103B of the mask 101. However, the entire interior of the opaque region 103B must be scanned for clear defects. In this case there is essentially no leakage of the beamlets into the transparent regions 103A, so the defect detection signal will be cleaner. The contributions from these edges could be reduced by keeping the edges of the beamlets away from the edges of the mask patterns. However, this is precisely where any opaque defects will lie in the transparent regions 103A, and a fraction of clear defects will lie near the edges of the opaque regions 103B. Therefore, a balance must be struck between degrading the defect signal and degrading the defect detection efficiency.

A study was done to estimate the performance of the inspection system 100 in the presence of these background considerations. The results described below show that sensitive defect detection by the invention is still possible under these more realistic conditions. The edgewidth was represented by the convolution of a gaussian point spread function with a square edge, producing an edgewidth with a shape defined by the error function Erf(x/σ), where σ is the standard deviation of the gaussian function. The edgewidth (12%-88%) was assumed to be 30 nm. In FIG. 14A, 1404 is the 88% intensity level, and 1406 is the 12% intensity level. The corresponding standard deviation σ (edgewidth=2.35σ) is 12.77 nm. The fraction of beamlet lost to the opaque region 103B of the mask 101 surrounding a square transparent region 103A of size s was calculated for a beamlet whose nominal size (full width at half maximum (fwhm)−1408 in FIG. 14A) was smaller than the opening by 2xσ, where x=2.5−4.0. In other words the nominal size of the beam let was s−2xσ.

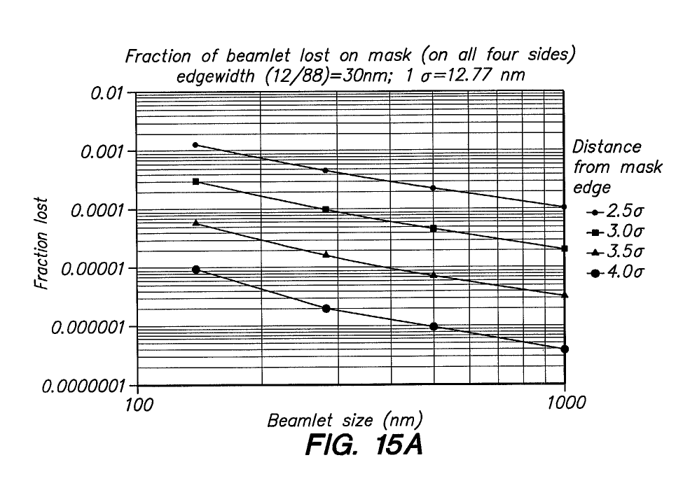

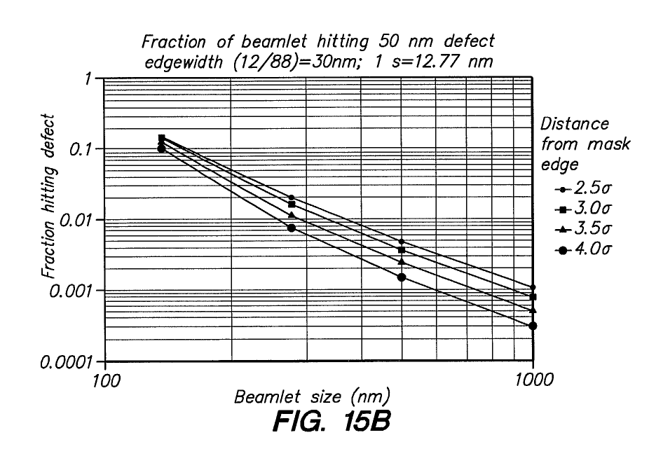

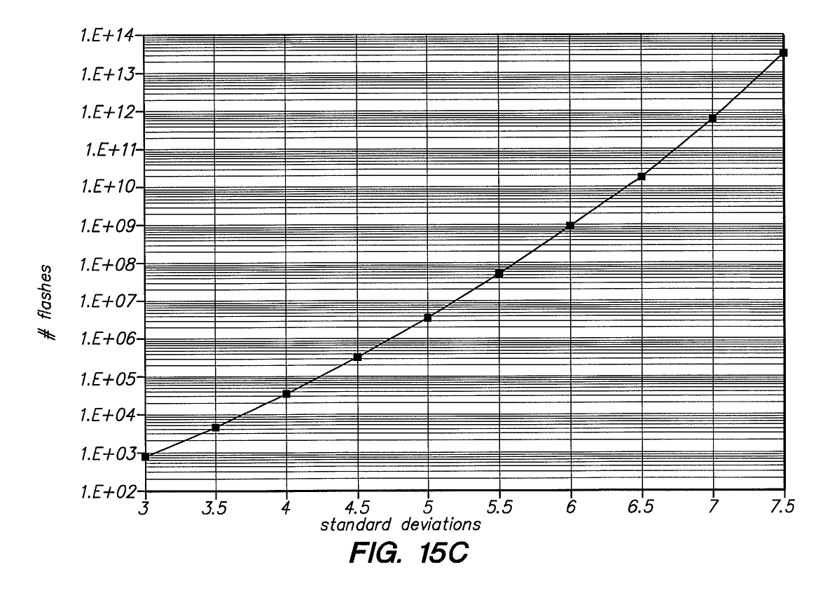

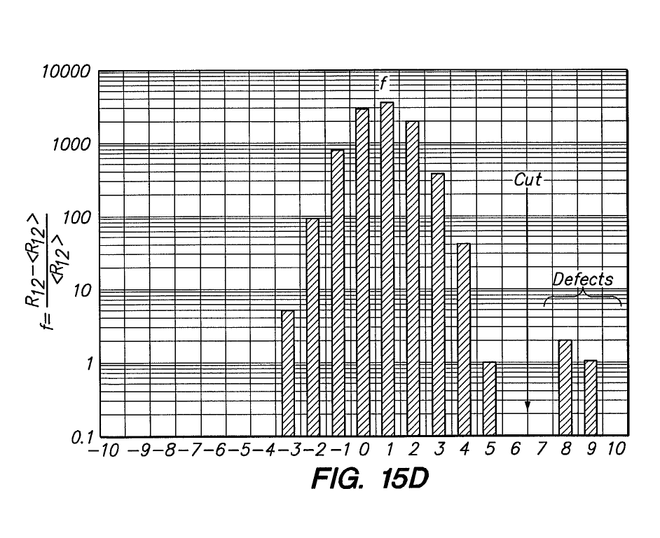

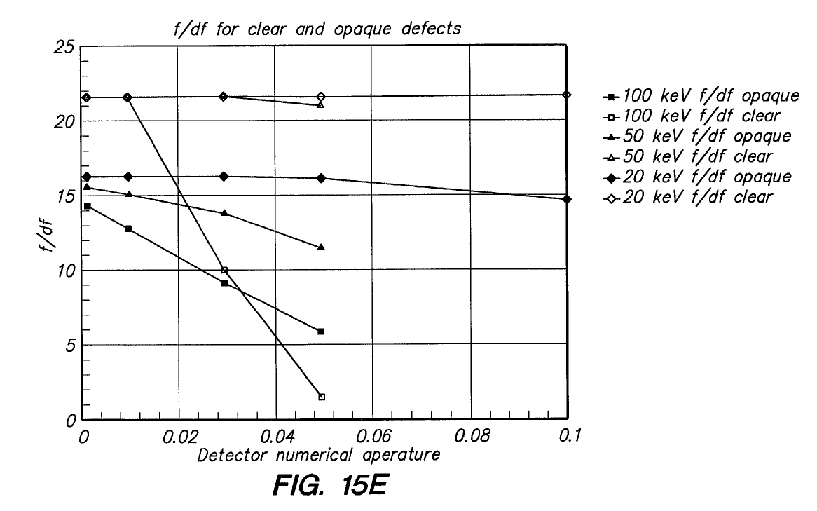

FIG. 15A is a graph that illustrates the fraction f_{c} of a beamlet hitting the mask for a range of beamlet sizes and distances x of the beam edge from a square shaped transparent region 103A in the mask 101. FIG. 15B is a graph that illustrates the fraction fₕᵢₜ of a beamlet hitting an opaque defect 50 nm square at the edge of the opening of the mask 101 for a range of beamlet sizes and distances x.

In a real system, the edge profile and the quantities described above would be measured by deflecting the beamlets across a straightedge as is well known in the art of electron optics and electron beam lithography.

Signal/Noise Considerations

The detectors 182, 184, 186 are assumed to be shot noise limited. With this design, the signal in each detector 182, 184, 186 will be proportional to the number of electrons N hitting the particular detector during the measurement time. For constant conditions, the number N will fluctuate according to a Poisson distribution. For large values of N this will approximate a normal distribution with mean N and standard deviation σ=N^{1/2}.

Consider the signals from the first detector 182 and the second detector 184. For the discussion below, the following quantities are defined:

I₁₀=the signal from the first detector 182 with no defects; # electrons=N₁₀;

I₂₀=the signal from the second detector 184 with no defects; # electrons=N₂₀;

I₁=the signal from the first detector 182 with a defect; # electrons=N₁;

I₂=the signal from the second detector 184 with a defect; # electrons=N₂.

Further, R₁₂₀=I₂₀/I₁₀ and R_{12d}=I₂/I₁. These ratios are very insensitive to beam current fluctuations or other systematic errors that do not influence the detector collection efficiencies. From conventional error theory, the statistical errors are

δR₁₂₀/R₁₂₀=[1/N₁₀+1/N₂₀]^{1/2}, (1)

and

δR_{12d}/R_{12d}=[1/N₁+1/N₂]^{1/2}. (2)

Then define the quantity

f=(R_{12d}−R₁₂₀)/R₁₂₀. (3)

If this quantity is significantly different from zero, a defect is present. The definition of significance is related to the number of false positives (apparent defects) that the operators of the inspection system are willing to tolerate. If the number of false positives is to be kept small, the magnitude of f should be significantly larger than its statistical error.

The error in f can be shown to be

δf=(1+f)[(δR₁₂₀/R₁₂₀)²+(δR_{12d}/R_{12d})²]^{1/2}=(1+f)[1/N₁₀+1/N₂₀+1/N₁+1/N₂]^{1/2}. (4)

For reliable detection of real defects f/δf should be substantially greater than 1. The properties of the normal distribution can be used to estimate this value. The probability that a defect free area of the mask will yield a value of f equal to or greater than nσ, if we now let σ=δf, is given by the cumulative normal distribution

$$P ( f \geq n σ ) = \frac{1}{\sqrt{2 π σ}} {\int }_{n σ}^{∞} exp [ \frac{- {u}^{2}}{2 {σ}^{2}} ] ⅆ u \qquad ( 5 )$$

Suppose the operator of the inspection system wants to limit the number of false positives to approximately 1 per mask. If the total number of beam flashes required to completely cover the mask (both transparent and opaque regions) is N_{f}, then we require approximately

P(f≧nσ)N_{f}≈1. (6)

The quantity n can be estimated from Eq. 6. N_{f} is estimated as follows. Assuming a chip size of 25 mm on a side, the mask area is approximately (4×25)²=10⁴ mm². The maximum area exposed per flash is N_{A}×2.5×10⁻⁷ mm², where N_{A} is the number of unblanked ABAA beamlets, of maximum size 0.5 μm. A complicated pattern might require more flashes, because a smaller beamlet size is needed. On the other hand, as mentioned earlier, only the perimeters of open areas need to be examined for defects; this reduces N_{f}. In any case a lower limit to N_{f} was estimated from

N_{f}=10⁴ mm²/(N_{A}×2.5×10⁻⁷ mm²)=4.0×10¹⁰/N_{A}. (7)

The number of flashes satisfying equation 6 as a function of nσ is shown in FIG. 15C. For N_{A}=1000 e.g. we need at least n>5.5 approximately, to avoid more than one false positive event; that is f must be greater than 5.5 times its statistical error. For N_{A}=10,000 we need n>5.0 approximately.

The parameter space for the inspection system has not been explored fully. However, all defects in the mask can be detected according to the above criteria for the following conditions: N_{A}=10,000, beam current at the mask=3.92 μA, central opening Detector 2≈10 mrad. Additional improvements are likely as this system is studied further.

Assuming a deflector settling time of 25 μsec, and the above conditions, the inspection time for a mask, exclusive of stage and other system overheads, would be

N_{f}×125×10⁻⁶ sec≈4.0×10¹⁰/N_{A}×125×10⁻⁶=500 sec=8.3 min.

For Na=1000, this is increased to 5000 sec=1.4 Hr.

Compared to conventional inspection systems, these times are quite short.

Defect Signals and Detection Efficiencies

The signals in the detectors were calculated as follows, using the definitions in Table 2.

TABLE 2

| | |
|---|---|
| J(x,y) | Beamlet current density at mask (x = y = 0 |
| | define the beamlet center) |
| η | BSE coefficient |
| ε | BSE detector collection efficiency |
| T(α,t) | transmission through mask membrane of |
| | thickness t, scattering angle ≦ α |
| α₁ | angular acceptance of transmission Detector 1 |
| α₂ | minimum angle of annular Detector 2 |
| f_{c} | fraction of beamlet hitting membrane |
| | surrounding clear areas, with no defects |
| fₒ | fraction of beamlet missing membrane in |
| | opaque regions, with no defects |
| fₕᵢₜ | fraction of beamlet hitting opaque defect at edge |
| | of mask opening |
| a | beamlet area (measured at fwhm point) |
| a′ | defect area |

Quantities with the subscript d refer to the defect. The transmission function T(α,t) is calculated from the elastic and inelastic electron scattering cross sections as described below. The angle α₁ is the angle corresponding to the aperture in front of the first detector. The maximum current incident on the mask is given by I=N_{A}aJ(0,0). The signals for the three detectors were calculated as follows, for four different cases.

1. Checking open areas—no defects.

a. first detector 182: I(1−f_{c})+If_{c}T(α₁, t)(1−η) (8)

b. second detector 184: If_{c}(1−T(α₂, t))(1−η) (9)

c. third detector 186: εηIf_{c} (10)

2. One opaque defect at the edge of a mask opening, area a′. The current incident on the defect is given by

I_{d}=∫∫_{a′}J(x,y)dxdy=fₕᵢₜa′J(0,0) (11)

where fₕᵢₜ is given in FIG. 15B.

a. first detector 182: (I−I_{d})(1−f_{c})+(I−I_{d})f_{c}T(α₁, t)(1−η)+I_{d}T(α₁, t_{d})×(1−η_{d}) (12)

b. second detector 184: (I−I_{d})f_{c}(1−T(α₂, t))(1−η)+I_{d}(1−T(α₂, t_{d}))×(1−η_{d}) (13)

c. third detector 186: ε(ηIf_{c}+η_{d}I_{d}) (14)

3. Checking opaque areas—no defects.

a. first detector 182: Ifₒ+I(1−fₒ)T(α₁, t)(1−η) (15)

b. second detector 184: I(1−fₒ)(1−T(α₂, t))(1−η) (16)

c. third detector 186: εηI(1−fₒ) (17)

4. One clear defect, area a′. At the edge of the opaque area the fraction of beam passing through the defect should equal that for an opaque defect at the edge of a clear region, Equation 11. In the interior of the opaque region, however, the current passing through the defect is just given by I_{d}=a′J(0,0).

a. first detector 182: (I−I_{d})fₒ+I_{d}+(I−I_{d})(1−fₒ)T(α₁, t)(1−η) (18)

b. second detector 184: (I−I_{d})(1−fₒ)(1−T(α₂, t))(1−η) (19)

c. third detector 186: εη(I−I_{d})(1−fₒ) (20)

In the following, for simplicity, it was assumed that α₁=α₂=α.

Results

Equations 8-20 were evaluated using the values in the following Table 3. f_{c} represents the fraction of a square beamlet partially overlapping the edges of a mask opening on all four sides. fₒ represents the situation where a square beamlet overlaps the edges of an opaque area on two sides (the case of a beamlet overlapping the edges of an opaque region on four sides is impossible). The minimum beamlet size used was 280 nm, which corresponds to a minimum feature size on the wafer of 70 nm. A beam energy of 20 keV was assumed.

TABLE 3

| | | |
|---|---|---|
| J(0,0) | 1 | A/cm² |
| α | 0.01 | |
| t | 1 | μm |
| t_{d} | 0.1 | μm |
| T(α,t) | 2.3 × 10⁻³⁷ | |
| T(α,t_{d}) | 2.17 × 10⁻⁴ | |
| f_{c} | 9.59 × 10⁻⁵ | |
| fₒ | 4.80 × 10⁻⁵ | |
| fₕᵢₜ | 0.0156 | |
| I | 3.92 | μA |

For the conditions used, the backscattered electron signal received by the third detector 186 was too weak to provide useful information and was not considered further.

The results are summarized in Table 4 below. The quantity f defined in Equation 3 is shown along with its error δf and the ratio f/δf. f/δf is far in excess of 5 standard deviations, so from the discussion associated with Equations 5, 6, 7, f is a significant signal for both clear and opaque defects, and the probability of f predicting a false positive during a mask inspection is very low. Clearly, therefore, more beamlets could be used and shorter integration times, leading to still higher throughput, without introducing false positives into the results.

The signal to noise estimates, and related throughput considerations may be conservative. For example the opaque defect thickness was assumed to be only a tenth that of the membrane. This may be reasonable if the defect is produced during the membrane etching step. If the defect occurs during the mask writing step, it should have the same thickness as the membrane after processing. This would substantially increase the defect signal. Also, the signal for clear defects in the membrane is estimated from Eqs. 15-20, where the beamlets are assumed to partially overlap openings in the membrane. However, in the interior of opaque regions, where the beamlets are totally intercepted by the membrane, the defect signal to noise will be significantly better, reflecting conditions similar to those described in Table 1.

The signals R_{12d} and R₁₂₀ depend only on the beamlet size, the mask transmission, the backscattered coefficient, and the fraction of the beamlet perimeter overlapping a mask edge. Using Equations 8 and 9, and 15 and 16, the theoretical values for R₁₂₀ are

$$\begin{matrix}{R}_{120 clear} = \frac{{f}_{c} ( 1 - T ( α , t ) ) ( 1 - η )}{1 - {f}_{c} + {f}_{c} T ( α , t ) ( 1 - η )} & ( 21 ) \\ {R}_{120 opaque} = \frac{( 1 - {f}_{o} ) ( 1 - T ( α , t ) ) ( 1 - η )}{{f}_{o} + ( 1 - {f}_{o} ) T ( α , t ) ( 1 - η )} & ( 22 )\end{matrix}$$

TABLE 4

| | # electrons | | | |
|---|---|---|---|---|
| Detector | in 100 μsec | f | δf | f/δf |
| a. Checking open areas - no | | | | |
| defects. | | | | |
| 1 | 2.4498e9 | | | |
| 2 | 2.0737e5 | | | |
| R₁₂₀ | 8.4647e−5 | | | |
| b. One opaque defect | | | | |
| 1 | 2.4498e9 | | | |
| 2 | 2.1493e5 | | | |
| R_{12d} | 8.7737e−5 | 0.03650 | 0.00022 | 16.3 |
| c. Checking opaque areas - | | | | |
| no defects. | | | | |
| 1 | 1.1751e5 | | | |
| 2 | 2.1615e9 | | | |
| R₁₂₀ | 5.4366e−5 | | | |
| d. One clear defect | | | | |
| 1 | 1.2518e5 | | | |
| 2 | 2.1615e9 | | | |
| R_{12d} | 5.7911e−5 | 0.0652 | 0.00301 | 21.7 |

Given the very small values of T(α,t) in Table 3, as well as the small backscattered electron coefficient η, these expressions can be well approximated by

R_{120clear}≈f_{c} (23)

R_{120opaque}≈1/fₒ, (24)

which depend only on the beamlet size and the fraction of the beamlet perimeter overlapping a mask edge. Thus, many exposures will contribute to a given R₁₂₀. Therefore the signals from a number of flashes can be combined to determine R₁₂₀, and the statistical error associated with R₁₂₀ will be negligible compared to that for R_{12d}; therefore it was not included in Table 4 results.

In reality what we measure is R₁₂, the ratio of signals from the first detector 182 and the second detector 184, which could be either R₁₂₀ or R_{12d}. The presence of a defect must be determined statistically. By combining all measurements made with beamlets of a given shape and size and for similar measurement conditions on the mask, the mean value of R₁₂, <R₁₂>, can be well determined. Since mask defects are assumed to be quite rare, <R₁₂> is essentially R₁₂₀. Thus the quantity f should be equivalent to the experimentally determined quantity

f=(R₁₂−<R₁₂>)/<i R₁₂>, (25)

and the error in f is then δf=δR₁₂/<R₁₂>, where δR₁₂ is the standard deviation of the distribution of values of R₁₂ associated with the same values of f_{c} or fₒ. A defect is then associated with a shot where f exceeds nδR₁₂/<R₁₂>, where the number n is determined from Eq. 6. Thus the analysis presented above has been cast entirely in terms of experimentally determined quantities.

Furthermore, if the experimental values of R₁₂ are normalized to Equations 23 and 24, or more accurately to Eqs. 21 and 22, they should all have about the same value, aside from statistical fluctuations, and they can all be combined into a single global value of <R₁₂>. As provided above, however, a defect will lie significantly beyond the range of statistical fluctuations expected for the number of flashes needed to cover a mask. Detecting the defects amounts to making a histogram of normalized R₁₂ and finding those values lying beyond the number of standard deviations associated with false positives, as indicated schematically in FIG. 15D.

Some amount of calculation is required to determine the normalized R₁₂. However, the basic information needed for this tool is essentially what is needed to make the mask in the first place using an e-beam writer. In fact, if an ABAA exposure tool is used as the mask maker, the mask making information is identical to what is needed for inspection with the present tool. Moreover, the estimation of f_{c} and fₒ is very similar to the calculations required to make proximity effect corrections for the mask writer. Both involve convolutions of the patterns with a point spread function. In the past the point spread function used for proximity correction was a simple gaussian, as with the present invention. Therefore little intrinsically new information needs to be generated for this inspection machine beyond the original mask pattern data base.

Transmission Through Membranes

The performance of the ABAA inspection tool depends on the probability of electrons scattering from the mask membrane into the several detectors under various conditions. The scattering cross sections used were taken from G.Soum et al, in Electron Beam Interactions with Solids, SEM Inc., 1982, 173.

Both elastic σₑₗ and inelastic σᵢₙ scattering cross sections were used. The total cross section for scattering through an angle α is

σₜₒₜ(α)=σₑₗ(α)+σᵢₙ(α), (26)

and the total cross section for scattering through an angle equal to or greater than α is

$${σ}_{\geq α} = 2 π {\int }_{α}^{ϵ} {σ}_{Tot} ( {α}^{′} ) sin {α}^{′} ⅆ {α}^{′} \qquad ( 27 )$$

The cross sections were evaluated at the incident electron energy. Energy loss in the thin membrane was ignored. Strictly speaking the electron scattering angular distribution must be convoluted with the angular distribution of the electron beam, whose angular width is the numerical aperture of the beam. Then if the contrast aperture subtends an angle of αₒ at the front focal plane of the projection lens below the mask, the fraction of electrons passing through the contrast aperture hole and reaching the transmission detector is given by the transmission probability T(α₀,t):

T(α₀,t)=exp[−t/Λ(α₀)], (28)

where t is the thickness of the mask membrane, and

Λ(α₀)=1/nₘₐₛₖσ_{≧α0} (29)

is the mean free path for electrons scattering through an angle equal to or greater than α₀, and nₘₐₛₖ is the atomic density (#atoms/cm³) of the mask:

nₘₐₛₖ=N₀ρₘₐₛₖ/Mₘₐₛₖ; (30)

N₀ is Avogadro's number, ρₘₐₛₖ is the mask density, and Mₘₐₛₖ is the atomic weight of the mask material.

The transmission probability T(α₀,t) depends on the angle α₀, the membrane thickness t, and also the electron energy E. It largely determines the defect sensitivity of the inspection tool. Again setting α₁=α₂=α₀, Equations 8-20 were evaluated to determine f/δf as a function of α₀ and E. The other variables in Equations 8-20 were the same as before. The results are shown in FIG. 15E and show that defect sensitivity is generally higher for both clear and opaque defects at low values of E and α₀. However the dependence is not extreme.

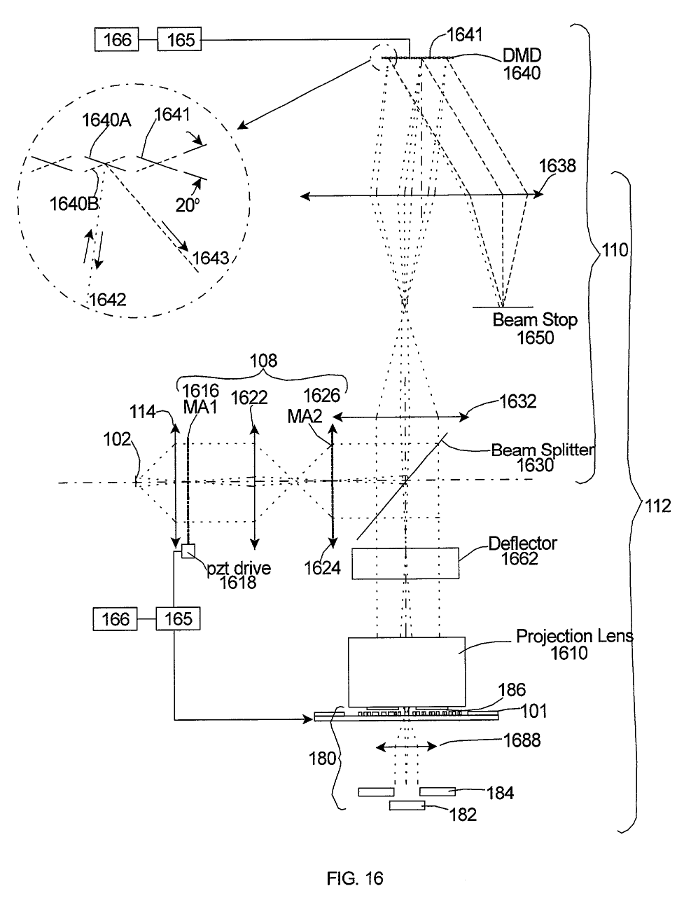

FIG. 16 describes another embodiment of the invention, which employs electromagnetic radiation rather than electrons to inspect the mask. This embodiment may be more suited for inspecting a scattering contrast membrane mask or a mask for a photolithography exposure tool. The electromagnetic radiation may be visible light, or it may be of wavelengths longer or shorter than the range of visible wavelengths depending on the application. In general, higher resolution inspection will be achieved with shorter wavelength radiation. The present embodiment is expected to function most effectively using either visible light or light in the ultraviolet (UV) or deep ultraviolet (DUV) wavelength ranges. Radiation from a radiation source 102 is collimated by a lens element 1614 and enters the beam shaping section 108 where it illuminates a first multi-aperture 1616. The first multi-aperture 1616 may be similar in construction to the multi-aperture 116 used with electrons, or it could be a thin plate transparent to the radiation and covered by a thin opaque layer of material patterned like the first multi-aperture 116, so that radiation is only transmitted through the regular arrays of apertures in the plate. The multi-apertures would then be very similar in construction to a chrome on glass photolithography mask. The aperture shapes in the array may be similar to those in the first multi-aperture array 116, or they may have some other shape, but they are all identical.

The radiation passing through the apertures in the first multi-aperture array 1616 becomes an array of beamlets which is focused with a lens element 1622 onto the plane of the second multi-aperture 1626. The second multi-aperture array 1626 may be of similar construction to the first multi-aperture array 1616, and it has a regular array of identical apertures whose shape may be similar to those in the second multi-aperture 126.

In order to change the shape of the beamlets transmitted through the second multi-aperture array 1626, the first multi-aperture array 1616 is translated transverse to the optical axis by mechanical drivers 1618, such as piezoelectric transducers. Several transducers are needed in order to drive the first multi-aperture array 1616 in the X direction or the Y direction, or some other direction in the X-Y plane (it is assumed the optical axis is in the Z direction). Position sensors (not shown) may monitor the movement of the first multi-aperture array 1616 in order to feedback position information to the mechanical drivers for greater accuracy.

The shaped beamlets then enter a beam blanking section 110. In this embodiment the beamlets are made parallel by a lens element 1624 and then deflected by a right angle beam splitter 1630. They then pass through a lens doublet consisting of lens elements 1632 and 1638, which focuses them onto a digital micromirror device, or DMD, 1640. The DMD consists of a regular array of small mirrors 1641 which can be independently tilted by electrical signals. The DMD is described in e.g. “A MEMS-Based Projection Display” by P. Van Kassel et al in Proceedings of the IEEE, Volume 86, 1687(1998). The particular embodiment employed here has square mirrors 16 μm on a side with a repeat distance of 17 μm. The DMD can have up to approximately 1.3 million independently controlled mirrors in its array, with each mirror playing the same role as a blanking aperture in the ABAA or BAA. Thus a very large number of shaped beamlets can be directed at the mask simultaneously.

In normal operation the DMD mirror position is bi-stable, with the mirror tilting about a single axis by ±10° and limited by mechanical stops at the extremes of the motion. The two stable orientations of the mirror are shown as 1640a and 1640b. The optical axis of lens element 1638 is offset from that of lens element 1632 so that a beamlet 1642 is deflected by the lens element 1638 and arrives approximately normally incident on the corresponding mirror when it is in orientation 1640a. It is then reflected approximately back on itself. If a mirror is placed in orientation 1640b, the reflected beam let 1643 is redirected through the lens element 1638 to a beam stop 1650. This defines the contrast mechanism of the beam blanking section 110.

The beamlets reflected from mirrors in orientation 1640a enter the lens group 112 which demagnifies them and focuses them onto the mask to be inspected 101. The lens group 112 includes the lens elements 1638 and 1632 and a projection lens 1610. The two multi-aperture arrays are optically conjugate to one another and to the DMD 1640 and to the plane of the mask 101. Since the micromirrors of the DMD 1640 are optically conjugate to the mask, the actual angle of the mirrors is not critical; the mirror orientation only determines whether a beamlet is blanked at the beam stop or not. It does not affect the beamlet locations at the mask 101.

The beamlets reaching the mask also pass through the beam splitter 1630, where half of the radiation is lost in partial reflections. Similarly half of the radiation is lost by the beamlets entering the beam splitter 1630 from the second multi-aperture array 1626. Therefore typically only about one quarter of the original beamlet intensity is available at the mask. The radiation source must be intense enough to compensate for this. Also the radiation lost at the beamsplitter 1630 must be controlled by means of beam stops and antireflection coatings (not shown), so that scattered radiation doesn't impair the signal contrast at the mask.

Alternatively, if a polarized source of radiation is used, a polarizing beam splitter followed by a quarter waveplate could be used, and the beamlet losses could be substantially eliminated.

The DMD is normally designed for display projection applications, and the surface quality of the micromirrors is not too critical. In the present applications, the micromirror surface may require additional processing during the array fabrication. It may require additional planarization, and it may require additional thin film coatings to enhance the beamlet reflectivity. This may be especially true if the wavelength of the light is in the UV or DUV region where the reflectivity of many reflective materials is not high.

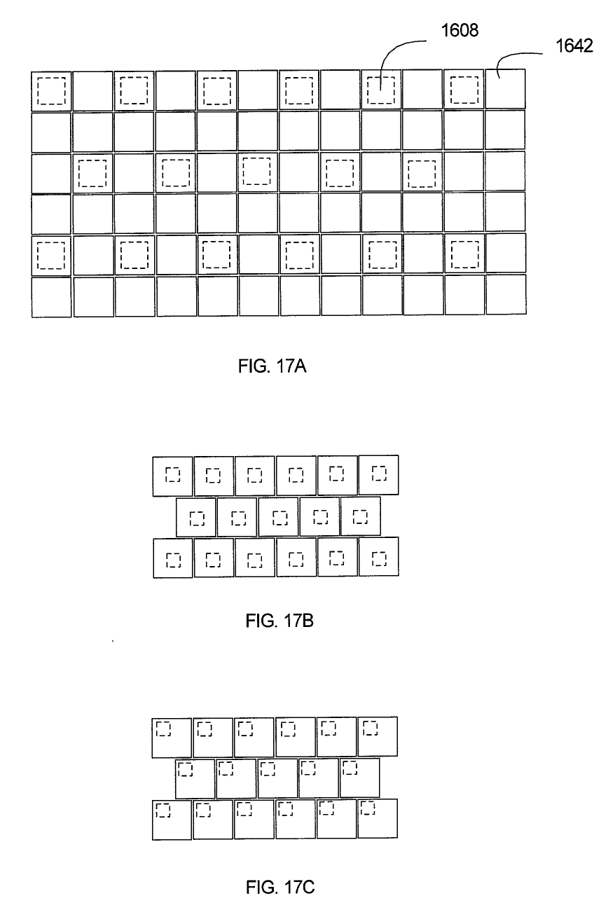

The lens doublet consisting of lens elements 1632 and 1638 functions as a telescope and adjusts the size of the beamlets to match the micromirror size. Depending on the DMD mirror geometry, two magnification settings are preferred. If the DMD mirrors are arrayed along the X and Y directions relative to one another, the magnification is adjusted so that the beamlet centers are at a distance of twice the DMD mirror pitch in the X and Y directions, as shown in FIG. 17A. The images of some of the apertures 1608 of the second multi-aperture array 1626 are shown as dashed figures superimposed on the DMD mirrors 1642. Note that only 25% of the DMD mirrors are used. However, if the DMD contains up to 1.3 million mirrors, this still permits as many as approximately 325,000 independently controlled beamlets. If every other row of DMD mirrors is offset from the adjacent row by one half a mirror pitch, however, then with a different magnification setting every DMD mirror can be used to reflect a beamlet, as shown in FIG. 17B.

If the center of each mirror is non-planar, due to processing operations, FIG. 17C shows how the beamlets can be moved off center to another part of the mirror which may be more planar.

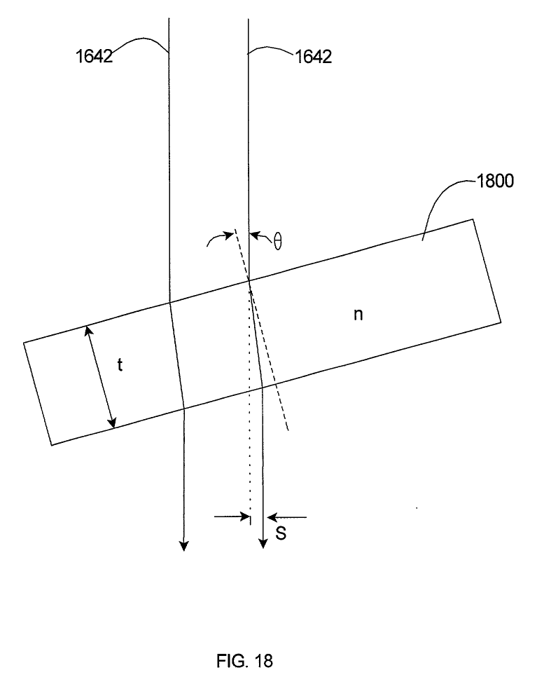

The beamlets are not adjacent, so in order to expose the regions between adjacent beamlets either the mask 101 must be displaced appropriately or the beamlets must be deflected. For the beamlet geometry shown in FIG. 5B, a total of 16 exposures are required to completely cover the area. A deflector 1662 is shown in FIG. 16, located where the beamlet directions are parallel. FIG. 18 shows one embodiment of the deflector 1662. The deflector consists of a transparent plate 1800 with flat parallel faces, which is rotated about an axis normal to the beamlet direction in order to displace the beamlets. If the plate thickness is t and the index of refraction of the material is n, the beamlets will be displaced parallel to themselves by an amount s when the plate normal is at an angle 0 to the incident beamlet direction:

s=t cos θ(tan θ−tan(θ/n)). (31)

The plate is tilted through an appropriate angle θ by mechanical drivers such as piezoelectric transducers (not shown) mounted near the edges of the plate. For example, if t=6 mm, n=1.5, and the beamlets are to be displaced a distance s=30 μm (at the deflector), the required tilt angle is approximately θ=15 mrad. Position sensors (not shown) may monitor the movement of the plate 1800 in order to feedback position information to the mechanical drivers for greater accuracy.

The beamlet resolution in this embodiment is determined by diffraction. If the wavelength of the radiation is λ, and the numerical aperture of the projection lens 1610 is NA, the first minimum in the diffraction pattern occurs at a distance from the geometrical edge of the beamlet at the mask of R=0.61λ/NA, and we adopt this quantity as the resolution of the tool. For example, if the wavelength of the radiation is 157 nm, corresponding to the emission wavelength of an F2 excimer laser, and NA=0.8, the resolution is about 120 nm.

If the multi-aperture arrays 1616 and 1626 are constructed using photolithography mask technology, the patterns and their placement can be controlled very precisely. In addition, the masks need not suffer thermal expansion effects of a comparable magnitude to that of the multi-apertures of the electron beam embodiment. In other words the multi-apertures of the present embodiment may be considered to be much more precise and stable. Therefore, the projection lens demagnification need not be as large. For example, an adequate projection lens demagnification might be 10. If the second multi-aperture 1626 aperture size is 10 μm, then the maximum beamlet size on the mask 101 is 1 μm, providing a beamlet size dynamic range of approximately 0.120 μm to 1 μm. The telescope consisting of lens elements 1632 and 1638 must then have a magnification which keeps the maximum size of the beamlet at the DMD 1640 smaller than the DMD mirrors 1641. In this example, the magnification of the telescope could be approximately 1. If the multi-aperture array consisted of 100 rows by 101 columns of apertures, the size of the array at the mask 101 would then be 404 μm by 400 μm.

The beamlet resolution described above was based on the assumption that aberrations in the projection lens 1610 are negligible compared to diffraction effects. Also, the aperture stop (not shown) in the projection lens 1610, which defines the numerical aperture NA of the projection lens, is assumed to be the system aperture stop. If other apertures upstream of the projection lens 1610 define a smaller range of radiation angles, the effective NA of the projection lens is reduced and the image resolution is degraded.

In addition, a DMD mirror 1641 acts as a field stop for each beamlet. In order to avoid perturbing the beamlet image, the beamlet should be sufficiently far from the mirror edges that a negligible amount of radiation diffracted from the beamlet at upstream apertures is intercepted by the mirror edges. For the conditions described above, a 10 μm beamlet centered on a 16 μm mirror, this requirement is met. Less than 5×10⁻⁴ of the diffracted light is lost.

The light source 102 is shown in FIG. 16 with a finite size so that it illuminates the multi apertures over a range of directions. This range of angles defines the degree of partial coherence of the light. In optical lithography, the partial coherence can significantly affect image quality, because the diffracted light from neighboring image features can overlap and interfere, if the features are close enough, and thus affect the feature image intensities. The selection of the proper partial coherence in optical lithography is understood; a description can be found e.g. in “Resolution Enhancement Techniques in Optical Lithography” by Alfred Wong. Since image features are created by individual beamlets separated by substantial distances in the present invention, there is essentially no overlap of the diffracted light from adjacent beamlets, and the degree of coherence of the illumination is of less importance.

The detector assembly 180 operates similar to that shown in the FIG. 1B embodiment, consisting of three detectors which detect reflected radiation (186), transmitted radiation (182), and scattered or diffracted radiation (184). A lens 1688, with detector 184 in its back focal plane, separates transmitted from scattered or diffracted radiation. A contrast aperture is not essential. The presence of a defect would affect the signals in the three detectors, as described above for the embodiment in FIG. 1B. However, diffraction might be expected to play a stronger role than the incoherent scattering processes of the electrons. For that reason, the degree of the coherence of the incident radiation may play a role in determining the defect sensitivity of the detectors. Because of its small size, a defect would be expected to diffract radiation at larger angles than would the larger mask patterns.

FIG. 19 illustrates an exposure apparatus for manufacturing a semiconductor wafer 1902 that utilizes a mask 101 that was inspected with an inspection system 100 (not shown in FIG. 19) having features of the present invention. The exposure apparatus 1900 is particularly useful as a lithographic device that transfers a pattern (not shown) of an integrated circuit from the reticle 101 onto the semiconductor wafer 1902. In this embodiment, the exposure apparatus 1900 includes a mounting frame 1904, an optical assembly 1906, an illumination system 1908 (irradiation apparatus), a reticle stage assembly 1910 and a wafer stage assembly 1912. The exposure apparatus 1900 is typically mounted to a mounting base 1914. The mounting base 1914 can be the ground, a base, or floor, or some other supporting structure.

The mounting frame 1904 is rigid and supports the components of the exposure apparatus 1904. The illumination system 1908 includes an illumination source 1916 and an illumination optical assembly 1918. The illumination source 1916 emits the irradiation. The illumination optical assembly 1918 guides the irradiation from the illumination source 1916 to the optical assembly 1906. The beam illuminates selectively different portions of the reticle 101 and exposes the wafer 1902.

The optical assembly 1906 projects and/or focuses the irradiation passing through reticle to the wafer. Depending upon the design of the apparatus 1900, the optical assembly 1906 can magnify or reduce the image created at the reticle. The above description of the exposure apparatus 1900 has been general, as far as the nature of the irradiation used to expose wafers is concerned.

The reticle stage assembly 1910 holds and precisely positions the reticle 101 relative to the optical assembly 1906 and the wafer 1902. Somewhat similarly, the wafer stage assembly 1912 holds and positions the wafer 1902 with respect to the projected image of the illuminated portions of the reticle 101.

While the particular inspection system 100 as herein shown and disclosed in detail are fully capable of obtaining the objects and providing the advantages herein before stated, it is to be understood that they are merely illustrative of embodiments of the invention and that no limitations are intended to the details of construction or design herein shown other than as described in the appended claims.

What is claimed is:

1. An inspection system for inspecting a mask to determine if the mask has at least one desired transparent area organized in a desired transparent pattern and at least one desired opaque area organized in a desired opaque pattern, the mask including at least one actual transparent area and at least one actual opaque area, the inspection system comprising:
a beamlet supply assembly that directs a shaped beamlet towards one of the actual areas of the mask, the shaped beamlet having a beamlet characteristic that corresponds to a desired characteristic of one of the desired areas.

2. The inspection system of claim 1 wherein the shaped beamlet has substantially the same cross-sectional size and shape as one of the desired areas.

3. The inspection system of claim 1 wherein the shaped beamlet has substantially the same cross-sectional size and shape as one of the desired opaque areas.

4. The inspection system of claim 1 wherein the shaped beamlet has substantially the same cross-sectional size and shape as one of the desired transparent areas.

5. The inspection system of claim 1 wherein the cross-sectional size and shape of the shaped beamlet is at least approximately fifty percent of the size and shape of one of the desired areas.

6. The inspection system of claim 1 wherein the beamlet supply assembly includes a source of electrons.

7. The inspection system of claim 1 further comprising a detector assembly that measures the magnitude of the signal that passes through at least a portion of the mask.

8. The inspection system of claim 7 wherein the magnitude of the signal of the beamlet at the mask is compared with the magnitude of the signal measured by the detector assembly to inspect the mask.

9. The inspection system of claim 1 further comprising a detector assembly that measures the magnitude of the signal that is reflected off of the mask.

10. The inspection system of claim 9 wherein the magnitude of the signal of the beamlet at the mask is compared with the magnitude of the signal measured by the detector assembly to inspect the mask.

11. The inspection system of claim 1 wherein the beamlet supply assembly directs a plurality of spaced apart, shaped beamlets substantially simultaneously towards the mask.

12. The inspection system of claim 11 wherein the beamlet supply assembly directs at least approximately ten spaced apart, shaped beamlets substantially simultaneously towards the mask.

13. The inspection system of claim 11 wherein the beamlet supply assembly directs at least approximately one hundred spaced apart, shaped beamlets substantially simultaneously towards the mask.

14. The inspection system of claim 11 wherein the beamlet supply assembly directs at least approximately one thousand spaced apart, shaped beamlets substantially simultaneously towards the mask.

15. The inspection system of claim 11 wherein the beamlet supply assembly directs at least approximately ten thousand spaced apart, shaped beamlets substantially simultaneously towards the mask.

16. The inspection system of claim 11 wherein the plurality of spaced apart beamlets are organized in a pattern that is substantially similar to at least a portion of one of the desired patterns.

17. The inspection system of claim 11 wherein the plurality of spaced apart beamlets are organized in a pattern that is substantially similar to at least a portion of the desired transparent pattern.

18. The inspection system of claim 11 wherein the plurality of spaced apart beamlets are organized in a pattern that is substantially similar to at least a portion of the desired opaque pattern.

19. The inspection system of claim 1 wherein the beamlet supply assembly includes a beamlet shaper that shapes the beamlet.

20. The inspection system of claim 19 wherein the beamlet shaper system of claim 19 wherein the beamlet supply assembly includes a beamlet blanker positioned between the beamlet shaper and the mask.

22. A mask inspected with the inspection system of claim 1.

23. An exposure apparatus that utilizes the mask of claim 22.

24. An object on which an image has been formed by the exposure apparatus of claim 23.

25. A semiconductor wafer on which an image has been formed by the exposure apparatus of claim 23.

26. An inspection system for inspecting a mask to determine if the mask has a plurality of desired transparent areas organized in a desired transparent pattern and a plurality of desired opaque areas organized in a desired opaque pattern, the mask including a plurality of actual transparent areas and a plurality of actual opaque areas, the inspection system comprising:
a beamlet supply assembly that directs a selectable plurality of spaced apart beamlets substantially simultaneously at the mask.

27. The inspection system of claim 26 wherein the beamlet supply assembly directs at least approximately ten spaced apart beamlets substantially simultaneously towards the mask.

28. The inspection system of claim 26 wherein the beamlet supply assembly directs at least approximately one hundred spaced apart beamlets substantially simultaneously towards the mask.

29. The inspection system of claim 26 wherein the beamlet supply assembly directs at least approximately one thousand spaced apart beamlets substantially simultaneously towards the mask.

30. The inspection system of claim 26 wherein the beamlet supply assembly directs at least approximately ten thousand spaced apart beamlets substantially simultaneously towards the mask.

31. The inspection system of claim 26 wherein the plurality of spaced apart beamlets are organized in a pattern that is substantially similar to one of the desired patterns.

32. The inspection system of claim 26 wherein the plurality of spaced apart beamlets are organized in a pattern that is substantially similar to at least a portion of the desired transparent pattern.

33. The inspection system of claim 26 wherein the plurality of spaced apart beamlets are organized in a pattern that is substantially similar to at least a portion of the desired opaque pattern.

34. The inspection system of claim 26 wherein at least one of the beamlets is a shaped beamlet and has a beamlet characteristic that corresponds to a desired characteristic of one of the desired areas.

35. The inspection system of claim 34 wherein the shaped beamlet has substantially the same cross-sectional size and shape as one of the desired areas.

36. The inspection system of claim 34 wherein the shaped beamlet has substantially the same cross-sectional size and shape as one of the desired opaque areas.

37. The inspection system of claim 34 wherein the shaped beamlet has substantially the same cross-sectional size and shape as one of the desired transparent areas.

38. The inspection system of claim 26 further comprising a detector assembly that measures the magnitude of the signal that passes through at least a portion of the mask.

39. The inspection system of claim 38 wherein the calculated magnitude of the signal of the beamlet at the mask is compared with the magnitude of the signal measured by the detector assembly to inspect the mask.

40. The inspection system of claim 26 further comprising a detector assembly that measures the magnitude of the signal that is reflected off of the mask.

41. The inspection system of claim 40 wherein the calculated magnitude of the signal of the beamlet at the mask is compared with the magnitude of the signal measured by the detector assembly to inspect the mask.

42. The inspection system of claim 26 wherein the beamlet supply assembly includes a beamlet shaper that shapes the beamlets.

43. The inspection system of claim 42 wherein the beamlet shaper includes a first multiple aperture array having apertures with a first shape and a second multiple aperture array having apertures with a second shape.

44. The inspection system of claim 42 wherein the beamlet supply assembly includes a beamlet blanker positioned between the beamlet shaper and the mask.

45. A mask inspected with the inspection system of claim 26.

46. An exposure apparatus that utilizes the mask of claim 45.

47. An object on which an image has been formed by the exposure apparatus of claim 46.

48. A semiconductor wafer on which an image has been formed by the exposure apparatus of claim 46.

49. An inspection system for inspecting a mask, the inspection system comprising:
a source of electrons;
a stage supporting the mask;
a beamlet shaping section disposed between the source of electrons and the mask, the beamlet shaping section including a first multi-aperture array having apertures with a first shape and a second multi-aperture array having apertures with a second shape;
a beamlet blanking section disposed between the beamlet shaping section and the mask;
a first electron lens group directing electrons emitted from the source of electrons into a collimated beam in an axial direction towards the first multi-aperture array;
a second electron lens group directing each beamlet in the array of electron beamlets formed by the first multi-aperture array towards the center of a corresponding aperture in the second multi-aperture array;
an electron deflector disposed between the first multi-aperture array and the second multi-aperture array; and
a detector assembly that measures electrons to inspect the mask.

50. The inspection system of claim 49 wherein the beamlet blanking section comprises an active blanking aperture array having a plurality of apertures.

51. The inspection system of claim 50 wherein further comprising:
a third electron lens group to direct each beamlet in the array of beamlets having the selected shape towards a corresponding aperture in the active blanking aperture array;
a logic circuit associated with each aperture in the active blanking aperture array to deflect selected electron beamlets passing through the active blanking aperture array;
a contrast aperture to absorb the selected electrons beamlets deflected by the active blanking aperture array and to absorb x-rays generated by electrons striking surfaces in the electron-beam lithography system; and
a fourth electron lens group to focus the electron beamlets passing undeflected through the active blanking aperture array onto the mask.

52. The inspection system of claim 51 further comprising first active blanking aperture array shield having M rows and N columns of apertures corresponding to the apertures in the active blanking aperture array and wherein the first active blanking aperture array shield is disposed between the second multi-aperture array and the active blanking aperture array.

53. The inspection system of claim 52 wherein the first active blanking aperture array shield comprises a layer of a low atomic number material and a layer of a high atomic number material.

54. The inspection system of claim 53 further comprising a second active blanking aperture array shield having M rows and N columns of apertures corresponding to the apertures in the active blanking aperture array and wherein the second active blanking aperture array shield is disposed between the active blanking aperture array and the object to be exposed.

55. The inspection system of claim 54 wherein the second active blanking aperture array shield comprises a layer of a low atomic number material and a layer of a high atomic number material.

56. The inspection system of claim 55 wherein the system further comprising a first multi-aperture array shield having M rows and N columns corresponding to the apertures in the first multi-aperture array and wherein the first multi-aperture array shield is disposed between the source of electrons and the first multi-aperture array.

57. The inspection system of claim 56 wherein the first multi-aperture array shield comprises a layer of a low atomic number material and a layer of a high atomic number material.

58. The inspection system of claim 57 further comprising a second multi-aperture array shield having m rows and n columns corresponding to the apertures in the second multi-aperture array and wherein the second multi-aperture array shield is disposed between the first multi-aperture array and the second multi-aperture array.

59. The inspection system of claim 58 wherein the second multi-aperture array shield comprises a layer of a low atomic number material and a layer of a high atomic number material.

60. The inspection system of claim 59 further comprising at least one x-ray baffle.

61. The inspection system of claim 60 wherein the at least one x-ray baffle is disposed between the second multi-aperture array and the active blanking aperture array.

62. The inspection system of claim 61 wherein the fourth electron lens group comprises:
a first symmetric magnetic doublet disposed between the active blanking aperture array and the surface to be exposed; and
a second symmetric magnet doublet disposed between the first symmetric magnetic doublet and the object to be exposed.

63. The inspection system of claim 62 further comprising a deflection system disposed in the second symmetric magnetic doublet to deflect each electron beamlet onto a portion of the mask.

64. The inspection system of claim 63 further comprising a control unit coupled to:
the electron deflector;
each logic circuit associated with each aperture in the active blanking aperture array;
the deflector system; and
the stage.

65. The inspection system of claim 64 wherein a contrast aperture is disposed at a crossover point of the first symmetric magnetic doublet.

66. The inspection system of claim 65 wherein the logic circuit associated with each aperture includes a memory unit to store a next pattern logic.

67. The inspection system of claim 49 wherein the source of electrons comprises an electron gun.

68. The inspection system of claim 49 wherein the source of electrons comprises an array of individual electron sources that produce an array of electron beamlets having M rows and N columns that correspond to the apertures of the first multi-blanking aperture array.

69. The inspection system of claim 49 wherein the detector assembly measures the magnitude of the signal that passes through at least a portion of the mask.

70. The inspection system of claim 69 wherein the magnitude of the signal at the mask is compared with the magnitude of the signal measured by the detector assembly to inspect the mask.

71. The inspection system of claim 69 wherein the detector assembly measures the magnitude of the signal that is reflected off of the mask.

72. The inspection system of claim 71 wherein the magnitude of the signal at the mask is compared with the magnitude of the signal measured by the detector assembly to inspect the mask.

73. A mask inspected with the inspection system of claim 49.

74. An exposure apparatus that utilizes the mask of claim 73.

75. An object on which an image has been formed by the exposure apparatus of claim 74.

76. A semiconductor wafer on which an image has been formed by the exposure apparatus of claim 74.

77. A method for inspecting a mask to determine if the mask has at least one desired transparent area organized in a desired transparent pattern and at least one desired opaque area organized in a desired opaque pattern, the mask including at least one actual transparent area and at least one actual opaque area, the method comprising the step of:
directing a shaped beamlet from a beamlet supply assembly towards one of the actual areas of the mask, the shaped beamlet having a beamlet characteristic that corresponds to a desired characteristic of one of the desired areas.

78. The method of claim 77 wherein the step of directing a shaped beamlet includes the step of directing a shaped beamlet having substantially the same cross-sectional size and shape as one of the desired areas.

79. The method of claim 77 wherein the step of directing a shaped beamlet includes the step of directing a shaped beamlet having substantially the same cross-sectional size and shape as one of the desired opaque areas.

80. The method of claim 77 wherein the step of directing a shaped beamlet includes the step of directing a shaped beamlet having substantially the same cross-sectional size and shape as one of the desired transparent areas.

81. The method of claim 77 wherein the step of directing a shaped beamlet includes the step of directing a shaped beamlet having a cross-sectional size and shape that is at least approximately ninety percent of the size and shape of one of the desired areas.

82. The method of claim 77 wherein the step of directing a shaped beamlet includes the step of providing a beamlet supply assembly having a source of electrons.

83. The method of claim 77 further comprising the step of measuring the magnitude of the signal that passes through at least a portion of the mask with a detector assembly.

84. The method of claim 77 further comprising the step of measuring the magnitude of the signal that passes through at least a portion of the mask with a detector assembly and comparing the signal measured by the detector assembly to the magnitude of the signal of the beamlet at the mask.

85. The method of claim 77 further comprising the step of measuring the magnitude of the signal that is reflected off of the mask with a detector assembly.

86. The method of claim 77 further comprising the step of measuring the magnitude of the signal that is reflected off of the mask with a detector assembly and comparing the signal measured by the detector assembly to the magnitude of the signal of the beamlet at the mask.

87. The method of claim 77 wherein the step of directing a shaped beamlet includes the step of providing a beamlet supply assembly that directs a plurality of spaced apart beamlets simultaneously towards the mask.

88. The method of claim 77 wherein the step of directing a shaped beamlet includes the step of providing a beamlet supply assembly that directs at least approximately ten spaced apart beamlets substantially simultaneously towards the mask.

89. The method of claim 77 wherein the step of directing a shaped beamlet includes the step of providing a beamlet supply assembly that directs at least approximately one hundred spaced apart beamlets substantially simultaneously towards the mask.

90. The method of claim 77 wherein the step of directing a shaped beamlet includes the step of providing a beamlet supply assembly that directs at least approximately one thousand spaced apart beamlets substantially simultaneously towards the mask.

91. The method of claim 77 wherein the step of directing a shaped beamlet includes the step of providing a beamlet supply assembly that directs at least approximately ten thousand spaced apart beamlets substantially simultaneously towards the mask.

92. The method of claim 77 wherein the step of directing a shaped beamlet includes the step of directing a plurality of spaced apart beamlets at the mask, the beamlets being organized in a pattern that is substantially similar to at least a portion of one of the desired patterns.

93. The method of claim 77 wherein the step of directing a shaped beamlet includes the step of directing a plurality of spaced apart beamlets at the mask, the beamlets being organized in a pattern that is substantially similar to at least a portion of the desired transparent pattern.

94. The method of claim 77 wherein the step of directing a shaped beamlet includes the step of directing a plurality of spaced apart beamlets at the mask, the beamlets being organized in a pattern that is substantially similar to at least a portion of the desired opaque pattern.

95. The method of claim 77 wherein the step of directing a shaped beamlet includes the step of providing a beamlet shaper that shapes the beamlet.

96. The method of claim 95 wherein the step of providing a beamlet shaper includes the step of providing a first multiple aperture array having apertures with a first shape and providing a second multiple aperture array having apertures with a second shape.

97. The method of claim 96 wherein the step of directing a shaped beamlet includes the step of providing a beamlet blanker positioned between the beamlet shaper and the mask.

98. A method for manufacturing a mask, the method including the step of providing a mask and the step of inspecting the mask with the method of claim 77.

99. A method for making an exposure apparatus that forms an image on a wafer, the method comprising the steps of:
providing an irradiation apparatus that irradiates the wafer with radiation to form the image on the wafer; and
providing a mask made by the method of claim 98.

100. A method of making a wafer utilizing the exposure apparatus made by the method of claim 99.

101. A method of making an object including at least the exposure process; wherein the exposure process utilizes the exposure apparatus made by the method of claim 99.

102. A method for inspecting a mask to determine if the mask has a plurality of desired transparent areas organized in a desired transparent pattern and a plurality of desired opaque areas organized in a desired opaque pattern, the mask including a plurality of actual transparent areas and a plurality of actual opaque areas, the method comprising the step of:
directing a plurality of spaced apart, selectable beamlets from a beamlet supply assembly substantially simultaneously at the mask.

103. The method of claim 102 wherein the step of directing a plurality of spaced apart beamlets includes the step of directing at least approximately ten spaced apart beamlets simultaneously towards the mask.

104. The method of claim 102 wherein the step of directing a plurality of spaced apart beamlets includes the step of directing at least approximately one hundred spaced apart beamlets simultaneously towards the mask.

105. The method of claim 102 wherein the step of directing a plurality of spaced apart beamlets includes the step of directing at least approximately one thousand spaced apart beamlets simultaneously towards the mask.

106. The method of claim 102 wherein the step of directing a plurality of spaced apart beamlets includes the step of directing at least approximately ten thousand spaced apart beamlets simultaneously towards the mask.

107. The method of claim 102 wherein the step of directing a plurality of spaced apart beamlets includes the step of organizing the beamlets in a pattern that is substantially similar to at least a portion of one of the desired patterns.

108. The method of claim 102 wherein the step of directing a plurality of spaced apart beamlets includes the step of organizing the beamlets in a pattern that is substantially similar to at least a portion of the desired transparent pattern.

109. The method of claim 102 wherein the step of directing a plurality of spaced apart beamlets includes the step of organizing the beamlets in a pattern that is substantially similar to at least a portion of the desired opaque pattern.

110. The method of claim 102 wherein the step of directing a plurality of beamlets includes the step of directing a shaped beamlet having substantially the same cross-sectional size and shape as one of the desired areas.

111. The method of claim 102 wherein the step of directing a plurality of beamlets includes the step of directing a shaped beamlet having substantially the same cross-sectional size and shape as one of the desired opaque areas.

112. The method of claim 102 wherein the step of directing a plurality of beamlets includes the step of directing a shaped beamlet having substantially the same cross-sectional size and shape as one of the desired transparent areas.

113. The method of claim 102 further comprising the step of measuring the magnitude of the signal that passes through at least a portion of the mask with a detector assembly.

114. The method of claim 102 further comprising the step of measuring the magnitude of the signal that passes through at least a portion of the mask with a detector assembly and comparing the signal measured by the detector assembly to the magnitude of the signal of the beamlet at the mask.

115. The method of claim 102 further comprising the step of measuring the magnitude of the signal that is reflected off of the mask with a detector assembly.

116. The method of claim 102 further comprising the step of measuring the magnitude of the signal that is reflected off of the mask with a detector assembly and comparing the signal measured by the detector assembly to the magnitude of the signal of the beamlet at the mask.

117. The method of claim 102 wherein the step of directing a plurality of beamlets includes the step of providing a beamlet shaper that shapes the beamlets.

118. The method of claim 117 wherein the step of providing a beamlet shaper includes the step of providing a first multiple aperture array having apertures with a first shape and providing a second multiple aperture array having apertures with a second shape.

119. The method of claim 117 wherein the step of directing a shaped beamlet includes the step of providing a beamlet blanker positioned between the beamlet shaper and the mask.

120. A method for manufacturing a mask, the method including the step of providing a mask and the step of inspecting the mask with the method of claim 102.

121. A method for making an exposure apparatus that forms an image on a wafer, the method comprising the steps of:
providing an irradiation apparatus that irradiates the wafer with radiation to form the image on the wafer; and
providing a mask made by the method of claim 120.

122. A method of making a wafer utilizing the exposure apparatus made by the method of claim 121.

123. A method of making an object including at least the exposure process; wherein the exposure process utilizes the exposure apparatus made by the method of claim 121.

124. A method for inspecting a device with electrons, the method comprising the steps of:
generating electrons;
directing the electrons in a collimated beam in an axial direction towards the device;
directing the collimated beam of electrons through a beamlet shaping section comprising a first multi-aperture array having M rows and N columns of apertures having a first shape, a second multi-aperture array having M rows and N columns of apertures having a second shape;
directing the electrons emerging from the beamlet shaping section through a beamlet blanking section;
directing electron beamlets having the first shape formed by the first multi-aperture array towards the center of corresponding apertures in the second multi-aperture array;
deflecting each of the electron beamlets formed by the first multi-aperture array away from the center of the corresponding aperture in the second multi-aperture array; and
measuring electrons with a detector assembly to inspect the device.

125. The method of claim 124 wherein directing the electrons through a beamlet blanking section comprises directing the electrons through an active blanking aperture array having M rows and N columns of apertures.

126. The method of claim 125 wherein the method further comprises:
directing each electron beamlet in the array of electron beamlets having the selected shape towards a corresponding aperture in the active blanking aperture array;
deflecting selected electron beamlets passing through the active blanking aperture array with logic circuits associated with each aperture in the active blanking aperture array;
absorbing the selected electrons beamlets deflected by the active blanking aperture array with a contrast aperture; and
focusing the electron beamlets passing undeflected through the active blanking aperture array onto the device.

127. The method of claim 126 wherein the method further comprises directing the electron beamlets having the selected shape through a first active blanking aperture array shield having M rows and N columns of apertures corresponding to the apertures in the active blanking aperture array and wherein the first active blanking aperture array shield is disposed between the second multi-aperture array and the active blanking aperture array.

128. The method of claim 127 wherein directing the electron beamlets having the selected shape through a first active blanking aperture array shield comprises directing the electron beamlets through a first active blanking aperture array shield comprising a layer of a low atomic number material and a layer of a high atomic number material.

129. The method of claim 128 wherein the method further comprises directing the electron beamlets having the selected shape through a second active blanking aperture array shield having M rows and N columns of apertures corresponding to the apertures in the active blanking aperture array and wherein the second active blanking aperture array shield is disposed between the active blanking aperture array and the device.

130. The method of claim 129 wherein directing the electron beamlets having the selected shape through a second active blanking aperture array shield comprises directing the electron beamlets through a second active blanking aperture array shield comprising a layer of a low atomic number material and a layer of a high atomic number material.

131. The method of claim 130 wherein the method further comprises directing the electron beamlets through a first multi-aperture array shield having M rows and N columns corresponding to the apertures in the first multi-aperture array and wherein the first multi-aperture array shield is disposed between the source of electrons and the first multi-aperture array.

132. The method of claim 131 wherein directing the electron beamlets through a first multi-aperture array shield comprises directing the electron beamlets through a first multi-aperture array shield comprising a layer of a low atomic number material and a layer of a high atomic number material.

133. The method of claim 132 wherein the method further comprises directing the electron beamlets through a second multi-aperture array shield having M rows and N columns corresponding to the apertures in the second multi-aperture array and wherein the second multi-aperture array shield is disposed between the first multi-aperture array and the second multi-aperture array.

134. The method of claim 133 wherein directing the electron beamlets through a second multi-aperture array shield comprises directing the electron beamlets through a second multi-aperture array shield comprising a layer of a low atomic number material and a layer of a high atomic number material.

135. The method of claim 134 wherein the method further comprises directing the electron beamlets through at least one x-ray baffle.

136. The method of claim 135 wherein directing the electron beamlets through at least one x-ray baffle comprises directing the electron beamlets through at least one x-ray baffle disposed between the second multi-aperture array and the active blanking aperture array.

137. The method of claim 136 wherein the method further comprises:
directing the electron beamlets through a first symmetric magnetic doublet disposed between the active blanking aperture array and the device; and
directing the electron beamlets through a second symmetric magnetic doublet disposed between the first symmetric magnetic doublet and the device.

138. The method of claim 137 wherein the method further comprises directing the electron beamlets through a deflection system disposed in the second symmetric magnetic doublet.

139. The method of claim 138 wherein the method further comprises controlling the electron deflector, each logic circuit associated with each aperture in the active blanking aperture array, the deflecting, and movement of a stage which supports the device with a control unit.

140. A method for manufacturing a device, the method including the step of providing a mask and the step of inspecting the mask with the method of claim 124.

141. A method for making an exposure apparatus that forms an image on a wafer, the method comprising the steps of:
providing an irradiation apparatus that irradiates the wafer with radiation to form the image on the wafer; and
providing a device made by the method of claim 140.

142. A method of making a wafer utilizing the exposure apparatus made by the method of claim 141.

143. A method of making an object including at least the exposure process; wherein the exposure process utilizes the exposure apparatus made by the method of claim 141.
